(19) United States
(12) Patent Application Publication
(10) Pub. No.: US 2025/0046842 A1
(43) Pub. Date: Feb. 6, 2025

(54) CONDITION-ESTIMATING DEVICE, FAULT-DETERMINING DEVICE, AND CONDITION-ESTIMATING/FAULT-DETERMINING DEVICE

(71) Applicants: KABUSHIKI KAISHA TOYOTA CHUO KENKYUSHO, Nagakute-shi, Aichi-ken (JP); DENSO CORPORATION, Kariya-shi, Aichi-ken (JP)

(72) Inventors: Takao WATANABE, Nagakute-shi (JP); Norihiro FUKAYA, Nagakute -shi (JP); Naoyuki YAMADA, Kariya-shi (JP); Naoya WAKAYAMA, Kariya-shi (JP); Kohei KAWABATA, Kariya-shi (JP)

(73) Assignees: KABUSHIKI KAISHA TOYOTA CHUO KENKYUSHO, Nagakute-shi, Aichi-ken (JP); DENSO CORPORATION, Kariya-shi, Aichi-ken (JP)

(21) Appl. No.: 18/716,418

(22) PCT Filed: Feb. 1, 2023
(86) PCT No.: PCT/JP2023/003185

§ 371 Date: Jun. 4, 2024

(30) Foreign Application Priority Data
Mar. 22, 2022 (JP) 2022-045822

(51) Int. Cl. H01M 8/04992; H01M 8/0432; H01M 8/04537; H01M 8/04664; H01M 8/10

(52) U.S. Cl. CPC H01M 8/04992; H01M 8/0432; H01M 8/04544; H01M 8/04664; H01M 2008/1095

(57) ABSTRACT

A condition-estimating device includes a first device that updates a parameter Pₘ[i] and an internal state Qₙ[i] included in a voltage estimation model of a polymer electrolyte fuel cell, a second device that successively acquires a current I[i] and a measured voltage value Vₘₑₛ[i], a third device that calculates an estimated voltage value Vₑₛₜ[i] by using the voltage estimation model including the updated Pₘ[i] and Qₙ[i], and a fourth device that corrects a correction factor CF[i] used for the update of Pₘ[i] and/or Qₙ[i] so as to decrease |Vₘₑₛ[i]−Vₑₛₜ[i]|. The fault-determining device includes a fault determination device that performs fault determination of a polymer electrolyte fuel cell by using Vₑₛₜ[i], P_{m_est}[i], and/or Q_{n_est}[i]. The condition-estimating/fault-determining device includes such condition-estimating device and fault-determining device.

### FIELD OF THE INVENTION

The present invention relates to a condition-estimating device, a fault-determining device, and a condition-estimating/fault-determining device, and more specifically, to a condition-estimating device, a fault-determining device, and a condition-estimating/fault-determining device capable of estimating the state of a polymer electrolyte fuel cell which has deteriorated over time and/or determining the presence or absence of fault of a polymer electrolyte fuel cell which has deteriorated over time.

### BACKGROUND OF THE INVENTION

A polymer electrolyte fuel cell includes a membrane electrode assembly (MEA) in which a catalyst layer containing a catalyst is bonded to both surfaces of an electrolyte membrane. The catalyst layer is a portion serving as a reaction field of an electrode reaction, and generally includes a composite of a carbon carrying catalyst particles such as platinum and a solid polymer electrolyte (catalyst layer ionomer).

In the polymer electrolyte fuel cell, a gas diffusion layer is usually disposed outside the catalyst layer. Further, a current collector (separator) including a gas flow path is disposed outside the gas diffusion layer. The polymer electrolyte fuel cell usually has a structure (fuel cell stack) in which a plurality of unit cells, each including such an MEA, a gas diffusion layer, and a current collector, are stacked.

When the polymer electrolyte fuel cell is used as an in-vehicle power source, the voltage of the polymer electrolyte fuel cell greatly fluctuates according to the traveling condition of the vehicle. When the polymer electrolyte fuel cell is in a low load state, the power generation efficiency becomes high, but a cathode catalyst is exposed to a high potential state, so that the catalyst component is easily eluted from the cathode catalyst. On the other hand, when the polymer electrolyte fuel cell is in a high load state, although the power generation efficiency becomes low, but the cathode catalyst is exposed to a low potential state, so that the eluted catalyst component is likely to be reprecipitated on the surface of the cathode catalyst. Therefore, when the cathode catalyst is repeatedly exposed to a high potential state and a low potential state, there is a problem that the cathode catalyst is gradually deteriorated.

On the other hand, the performance of the polymer electrolyte fuel cell is affected not only by a steady voltage reduction caused by such catalyst deterioration but also by temporary voltage fluctuation caused by fluctuation in power generation conditions (that is, voltage fluctuation caused by formation/reduction of oxide film on the catalyst surface). It is therefore difficult to accurately estimate the true performance of a polymer electrolyte fuel cell at the present time only by monitoring the voltage of the polymer electrolyte fuel cell that changes from moment to moment.

In order to solve this problem, various proposals have been made heretofore.

For example, Patent Literature 1 discloses a fuel cell power generation monitoring system that:
(a) measures a fuel cell stack voltage of a fuel cell power generation system;
(b) changes the fuel cell effective electrode area of a simulation model such that the stack voltage of the simulation model follows the fuel cell stack voltage; and
(c) determines that there is abnormal condition when the fuel cell effective electrode area in the simulation model is outside normal range.

The Patent Literature 1 describes that:
(A) by such a method, it is possible to accurately monitor a deterioration state inside the fuel cell power generation system; and
(B) using such a simulation model, it is possible to obtain a future predicted value of the fuel cell effective electrode area when operation is continued under the present condition.

The method described in Patent Literature 1 is a method of determining that the fuel cell is abnormal when the fuel cell effective electrode area is out of the normal range, and does not consider the temporary fluctuation in cell voltage. Therefore, the simulation model may be corrected by regarding the temporary fluctuation in the cell voltage as a change in the fuel cell effective electrode area. As a result, there is a possibility that an abnormality is detected even though the fuel cell is normal.

In addition, the method of Patent Literature 1 detects abnormality by using only the fuel cell effective electrode area and the abnormality detection accuracy is presumed to be low. Moreover, Patent Literature 1 does not disclose the simulation model and is therefore not specific.

Further, the performance of a fuel cell changes not only by a steady voltage reduction due to catalyst deterioration and temporary voltage fluctuation due to the formation/reduction of an oxide film on the catalyst surface but also by a voltage reduction due to a fault (an irreversible voltage reduction that accidentally occurs due to a cause other than catalyst deterioration). However, no such example of a fuel cell fault-determining device has been proposed previously, which is capable of accurately determining a voltage reduction caused by fault, without being affected by a steady voltage reduction or temporary voltage fluctuation.

### CITATION LIST

### Patent Literature

[Patent Literature 1] Japanese Unexamined Patent Application Publication No. 2007-305327

### SUMMARY OF THE INVENTION

An object of the present invention is to provide a condition-estimating device capable of estimating the net performance of a polymer electrolyte fuel cell which has deteriorated over time.

Another object of the present invention is to provide a fault-determining device capable of accurately determining the presence or absence of fault of a polymer electrolyte fuel cell.

Another object of the present invention is to provide a condition-estimating/fault-determining device capable of performing both state estimation and fault determination of a polymer electrolyte fuel cell.

In order to solve the above problems, the condition-estimating device according to the present invention includes:
(A) first means that stores, in a memory, a voltage estimation model which is used for calculating an estimated voltage value Vₑₛₜ[i] of a polymer electrolyte fuel cell at time[i] and includes at least one parameter Pₘ[i] at the time[i] and/or at least one internal state Qₙ[i] at the time[i],
calculates at least one selected from the group consisting of an estimated parameter value P_{m_est}[i] (m≥1) at the time[i] and an estimated internal state value Q_{n_est}[i] (n≥1) at the time[i] by using an estimated voltage value Vₑₛₜ[i−1], a measured voltage value Vₘₑₛ[i−1], and a correction factor CF[i−1] of the polymer electrolyte fuel cell at time[i−1], and
updates the Pₘ[i] and the Qₙ[i] based on the calculated P_{m_est}[i] and Q_{n_est}[i], respectively, and stores each of the updated Pₘ[i] and Qₙ[i] in the memory;
(B) second means that, before or after performing the first means, successively acquires a current I[i] and a measured voltage value Vₘₑₛ[i] of the polymer electrolyte fuel cell at the time[i] and stores them in the memory;
(C) third means that calculates the Vₑₛₜ[i] by using the voltage estimation model including the I[i], the Vₘₑₛ[i], and the updated Pₘ[i] and Qₙ[i] and stores the thus-calculated Vₑₛₜ[i] in the memory; and
(D) fourth means that calculates a corrected parameter Pₘ*[i] and/or a corrected internal state Qₙ*[i] by using, instead of the CF[i−1], a provisional correction factor CF*[i−1] arbitrarily selected from within a range between −δ₁ to +δ₂,
calculates a corrected value of estimated voltage Vₑₛₜ*[i] by using the voltage estimation model including the Pₘ*[i] and the Qₙ*[i],
determines whether or not the Vₑₛₜ*[i] satisfies the following determination formula: |Vₘₑₛ[i]−Vₑₛₜ*[i]|≤|Vₘₑₛ[i−1]−Vₑₛₜ[i−1]|, and stores, in the memory, the CF*[i−1] that satisfies the determination formula as a correction factor CF[i] at the time[i].

Here, the term “parameter Pₘ[i]” means a constant included in the voltage estimation model and a variable constant that may change the value depending on the Vₘₑₛ[i], and
the term “internal state Qₙ[i]” means a state quantity which is included in the voltage estimation model and may change with the time[i] but is other than the I[i] and the Vₘₑₛ[i].

The fault-determining device according to the present invention includes fault determination means that determines fault of a polymer electrolyte fuel cell by using at least one selected from the group consisting of:
(a) an estimated voltage value Vₑₛₜ[i] of the polymer electrolyte fuel cell at the time[i];
(b) an estimated parameter value P_{m_est}[i] (m≥1) at the time[i]; and
(c) an estimated internal state value Q_{n_est}[i] (n≥1) at the time[i],
each value being output from the condition-estimating device according to the present invention.

Further, the condition-estimating/fault-determining device according to the present invention includes:
the condition-estimating device according to the present invention; and
the fault-determining device according to the present invention.

By using a voltage estimation model, an estimated voltage value Vₑₛₜ[i] of a polymer electrolyte fuel cell at time[i] can be calculated. By using a voltage estimation model that takes into account a steady voltage reduction due to catalyst deterioration or temporary voltage fluctuation due to the formation/reduction of an oxide film, Vₑₛₜ[i] that takes into account the influence of the steady voltage reduction or the influence of the temporary voltage fluctuation can be obtained. Even when Vₑₛₜ[i] is calculated using such a voltage estimation model, however, Vₘₑₛ[i] sometimes cannot be reproduced completely. This is presumed to occur because there is variation in machine difference, modeling error, unknown factors which cannot be modeled, and the like.

On the other hand, in a case where Vₑₛₜ[i] is calculated using the voltage estimation model, when at least one of a parameter Pₘ[i] and an internal state Qₙ[i] included in the voltage estimation model is corrected so that the Vₑₛₜ[i] becomes closer to Vₘₑₛ[i] and the Vₑₛₜ[i] is calculated using the corrected Pₘ[i] and Qₙ[i], it is possible to prevent Vₑₛₜ[i] from deviating largely from Vₘₑₛ[i].

When there occurs, in a polymer electrolyte fuel cell, only a steady voltage reduction due to catalyst deterioration and/or temporary voltage fluctuation due to the formation/reduction of an oxide film, a value or changing manner of Pₘ[i] and Qₙ[i] can be found or estimated in advance. When a voltage reduction due to fault occurs, on the other hand, Vₑₛₜ[i] is less directly affected by the fault so that Vₑₛₜ[i] calculated using the voltage estimation model deviates largely from Vₘₑₛ[i].

When there occurs a fault, therefore, by correcting Pₘ[i] and/or Qₙ[i] to bring Vₑₛₜ[i] closer to Vₘₑₛ[i], the value or changing manner of Pₘ[i] and Qₙ[i] changes largely before and after the fault. As a result, the presence or absence of the fault can be estimated accurately based on a changing amount of Vₑₛₜ[i], Pₘ[i] before correction (that is, P_{m_est}[i]), and/or Qₙ[i] before correction (that is, Q_{n_est}[i]).

### BRIEF DESCRIPTION OF THE DRAWINGS

FIG. 1 is a cross-sectional schematic view of a Pt particle having an oxide film formed thereon.

FIG. 2 is a block diagram of a voltage estimation model.

FIG. 3 is a block diagram of a condition-estimating device having a voltage estimation model and correction means of a parameter Pₘ[i] and an internal state Qₙ[i].

FIG. 4 is a flow chart for carrying out the state estimation and fault determination according to a first embodiment of the present invention.

FIG. 5 is a flow chart for carrying out the state estimation and fault determination according to a second embodiment of the present invention.

### DETAILED DESCRIPTION OF PREFERRED EMBODIMENT

One embodiment of the present invention will hereinafter be described in detail.

### 1. Condition-Estimating Device

The condition-estimating device according to the present invention is equipped with first means, second means, third means, and fourth means.

### 1.1. First Means

The first means is a means that
stores, in a memory, a voltage estimation model which is used for calculating an estimated voltage value Vₑₛₜ[i] of a polymer electrolyte fuel cell at time[i] and includes at least one parameter Pₘ[i] at the time[i] and/or at least one internal state Qₙ[i] at the time[i],
calculates at least one selected from the group consisting of an estimated parameter value P_{m_est}[i] (m≥1) at the time[i] and an estimated internal state value Q_{n_est}[i] (n≥1) at the time[i] by using an estimated voltage value Vₑₛₜ[i−1], a measured voltage value Vₘₑₛ[i−1], and a correction factor CF[i−1] of the polymer electrolyte fuel cell at time[i−1],
updates the Pₘ[i] and the Qₙ[i] based on the calculated P_{m_est}[i] and Q_{n_est}[i], respectively, and stores each of the updated Pₘ[i] and Qₙ[i] in the memory.

### 1.1.1. Voltage Estimation Model

The term “voltage estimation model” means a physical model capable of calculating an estimated voltage value Vₑₛₜ[i] of a polymer electrolyte fuel cell at time[i] and including at least one parameter Pₘ[i] (m≥1) and/or at least one internal state Qₙ[i](n≥1).

The voltage estimation model may be a simple model capable of calculating Vₑₛₜ[i] only by using a current I[i] and a measured voltage value Vₘₑₛ[i] of a polymer electrolyte fuel cell at time[i] or may be a rigorous model capable of calculating Vₑₛₜ(i) by using, in addition to the I[i] and Vₘₑₛ[i], a measured temperature value Tₘₑₛ[i] and a measured ohmic resistance value Rᵢₒₙ[i] of the polymer electrolyte fuel cell at time[i]. Specific examples of the voltage estimation model will be described later.

When Vₘₑₛ[i], and Tₘₑₛ[i] and Rᵢₒₙ[i] that may be acquired as needed are found, a voltage estimation model (that is, an estimated value IVₑₛₜ[i] of current-voltage characteristics) representing the relation between a current I[i] and a voltage Vₑₛₜ[i] at time[i] can be obtained. By substituting I[i] into the voltage estimation model thus obtained, Vₑₛₜ[i] can be calculated.

The Vₑₛₜ[i] calculated using the voltage estimation model is stored as is in the memory. The Vₑₛₜ[i] is sometimes used for fault determination which will be described later.

### 1.1.2. Parameter Pₘ[i]

The term “Parameter Pₘ[i]” means a constant included in a voltage estimation model and a constant (variable constant) that may change its value depending on Vₘₑₛ[i].

The voltage estimation model includes a variable and a constant. The constant is roughly classified into:
(a) an invariable constant (such as Faraday constant and gas constant), and
(b) a variable for adjustment (a variable constant) that should inherently be a constant but may change its value in line with experimental results (measured value).

In the present invention, the term “Pₘ[i]” means the latter “variable constant”.

In other words, Pₘ[i] is a constant which may be adjusted depending on Vₘₑₛ[i], though it is apparently treated as a constant in a voltage estimation model.

For example, a state quantity which should be treated as a variable in a rigorous model is sometimes treated as a constant in a simple model. In the present invention, such a constant may be treated as “a variable constant” and its value may be adjusted.

In the present invention, the kind of Pₘ[i] is not particularly limited and the optimum one can be selected depending on the purpose.

The voltage estimation model preferably includes, particularly as Pₘ[i], at least one variable constant having a relation with a steady voltage reduction due to the deterioration of noble metal-based catalyst particles contained in a polymer electrolyte fuel cell. When a voltage estimation model includes such Pₘ[i], using such a voltage estimation model makes it possible to calculate Vₑₛₜ[i] that has taken into account the influence of a steady voltage reduction due to catalyst deterioration.

Examples of Pₘ[i] having a correlation with a steady voltage reduction include A₁, Cₒ₂, R_{gas}, Rᵢₒₙ, and αᵢ (i=1 to 4) included in the formulas (1) to (13) which will be described later. Details of them will be described later.

### [1.1.3. Internal State Qₙ[i]]

The term “internal state Qₙ[i]” means a state quantity that is included in the voltage estimation model and may change with the time[i] but is other than I[i] and Vₘₑₛ[i].

When a polymer electrolyte fuel cell is continuously operated, the circumstance inside the polymer electrolyte fuel cell changes from moment to moment. If the state quantity relating to a circumstantial change inside the fuel cell is regarded as a constant, the estimation accuracy of Vₑₛₜ[i] may decrease. On the contrary, adjustment of Qₙ[i] depending on a circumstantial change inside the polymer electrolyte fuel cell may improve the estimation accuracy of Vₑₛₜ[i].

In the present invention, the kind of Qₙ[i] is not particularly limited and the optimum one can be selected depending on the purpose.

The voltage estimation model preferably includes, as Qₙ[i], at least one state quantity having a correlation with a temporary voltage fluctuation due to the formation/reduction of an oxide film on the surface of noble metal-based catalyst particles contained in a polymer electrolyte fuel cell. When the voltage estimation model includes such Qₙ[i], using such a voltage estimation model makes it possible to calculate Vₑₛₜ[i] that has taken into account the influence of the temporary voltage fluctuation due to the formation/reduction of an oxide film.

Examples of Qₙ[i] having a correlation with the temporary voltage fluctuation include a coverage θₒₓⱼ[i] (j=1, 2, or 3) included in the formulas (18) to (20) which will be described later and a catalyst surface utilization ratio θ_{act}[i] calculated using the θₒₓⱼ[i]. Details of them will be described later.

### 1.1.4. Correction Factor CF[i−1]

The term “correction factor CF[i−1]” means a correction factor used for the calculation of an estimated parameter value P_{m_est}[i] and an estimated internal state value Q_{n_est}[i] at time[i].

The CF[i−1] is a value already calculated based on various physical quantities (for example, Vₑₛₜ[i−1] and Vₘₑₛ[i−1]) acquired at time[i−1] and stored in a memory.

On the other hand, the correction factor CF[i] at time[i] is calculated based on various physical quantities acquired at time[i] by the fourth means which will be described later. The calculation method of CF[i] will be described later. Further, the calculated CF[i] is stored in the memory and is used for the calculation of P_{m_est}[i+1] and Q_{n_est}[i+1] at time [i+1].

The CF[i−1] is used for correcting the deviation of Vₑₛₜ[i−1] from Vₘₑₛ[i−1] that occurs due to a cause other than the fault of a polymer electrolyte fuel cell such as a modeling error, steady voltage reduction, and temporary voltage fluctuation. When a difference between Vₑₛₜ[i−1] and Vₘₑₛ[i−1] is determined to fall within a permissible range, zero may be adopted as CF[i−1]. When a difference between Vₑₛₜ[i−1] and Vₘₑₛ[i−1] is determined to exceed a permissible range, a positive value or a negative value may be adopted as CF[i−1].

### [1.1.5. Update of Pₘ[i] and Qₙ[i]]

The first means is equipped with an updating means for updating Pₘ[i] and/or Qₙ[i].

The term “updating means” as used herein is a means that determines the value of Pₘ[i] or Qₙ[i] by using various data at time[i−1], which have been stored in the memory, based on a predetermined update rule, regardless of whether or not a fault or deterioration occurs in the polymer electrolyte fuel cell (in other words, regardless of whether or not the Vₑₛₜ[i] coincides with Vₘₑₛ[i]).

More specifically, the term “updating means” is a means that calculates at least one selected from the group consisting of an estimated parameter value P_{m_est}[i] (m≥1) at the time[i] and an estimated internal state value Q_{n_est}[i] (n≥1) at the time[i] by using the estimated voltage value Vₑₛₜ[i−1], the measured voltage value Vₘₑₛ[i−1], and the correction factor CF[i−1] of the polymer electrolyte fuel cell at time[i−1], and
updates the Pₘ[i] and the Qₙ[i] based on the calculated P_{m_est}[i] and Q_{n_est}[i], respectively, and stores each of the updated Pₘ[i] and Qₙ[i] in the memory.

The P_{m_est}[i] is calculated based on a relational formula (for example, formula (16) which will be described later) that includes Vₑₛₜ[i−1], Vₘₑₛ[i−1], and CF[i−1] and is predetermined. Then, Pₘ[i] is updated based on the P_{m_est}[i].

The term “Pₘ[i] is updated based on the P_{m_est}[i]” means that:
(a) the calculated P_{m_est}[i] is adopted as is as Pₘ[i]; or
(b) a predetermined determination formula (for example, the formula (17) which will be described later) is applied to the calculated P_{m_est}[i], and the P_{m_est}[i] or a value other than the P_{m_est}[i] is selected as Pₘ[i] based on the determination formula.

The P_{m_est}[i] calculated by the first means is stored in the memory as is. The P_{m_est}[i] is sometimes used for the fault determination which will be described later.

Similarly, the Q_{n_est}[i] is calculated based on a relational formula (for example, the formulas (18) to (20) which will be described later) that includes Vₑₛₜ[i−1], Vₘₑₛ[i−1], and CF[i−1] and is predetermined. Then, Qₙ[i] is updated based on the Q_{n_est}[i].

The term “Qₙ[i] is updated based on the Q_{n_est}[i]” means that:
(a) the calculated Q_{n_est}[i] is adopted as is as Qₙ[i]; or
(b) a predetermined determination formula (for example, the formula (21) which will be described later) is applied to the calculated Q_{n_est}[i], and the Q_{n_est}[i] or a value other than the Q_{n_est}[i] is selected as Qₙ[i] based on the determination formula.

The Q_{n_est}[i] calculated by the first means is stored in the memory as is. The Q_{n_est}[i] is sometimes used for fault determination which will be described later.

### 1.2. Second Means

The second means is a means that, before or after performing the first means, successively acquires a current I[i] and a measured voltage value Vₘₑₛ[i] of the polymer electrolyte fuel cell at the time[i] and stores them in the memory.

The second means is for acquiring a state quantity necessary for the calculation of Vₑₛₜ[i] and it does not have a direct influence on the update of Pₘ[i] and Qₙ[i]. The second means may therefore be performed before performing the first means or after performing the first means.

The following relationship P=I×V holds for power P, current I, and voltage V of a polymer electrolyte fuel cell. When a required power P_{ref} is required for the polymer electrolyte fuel cell, I and V are usually selected to give the highest efficiency. A commanded current value selected when P_{ref}[i] is requested at time[i] is set as I_{ref}[i]. The current I[i] acquired in the second means may be either the commanded current value I_{ref}[i] at time[i] or a measured current value Iₘₑₛ[i] at time[i]. The same results can be obtained by using either of them.

The second means may further include a means that acquires, in addition to I[i] and Vₘₑₛ[i], a measured temperature value Tₘₑₛ[i] of the polymer electrolyte fuel cell at time[i] and a measured ohmic resistance value Rᵢₒₙ[i] of the polymer electrolyte fuel cell at time[i] and stores them in the memory.

As described above, in the present invention, an estimated voltage value Vₑₛₜ[i] of the polymer electrolyte fuel cell at time[i] is calculated using a voltage estimation model. Such a voltage estimation model includes various models ranging from a simple model to a rigorous model. The Tₘₑₛ[i] and Rᵢₒₙ[i] are used for calculating an estimated voltage value Vₑₛₜ[i] of the polymer electrolyte fuel cell at time[i] by using the voltage estimation model (rigorous model) including them. For the calculation of Vₑₛₜ[i] using a simple model, therefore, it is not always necessary to acquire Tₘₑₛ[i] and Rᵢₒₙ[i].

### 1.3. Third Means

The third means is a means that calculates the Vₑₛₜ[i] by using the voltage estimation model including the I[i], the Vₘₑₛ[i], and the updated Pₘ[i] and Qₙ[i] and stores the thus-calculated Vₑₛₜ[i] in the memory.

When the second means includes a means that acquires a measured temperature value Tₘₑₛ[i] of the polymer electrolyte fuel cell at time[i] and a measured ohmic resistance value Rᵢₒₙ[i] of the polymer electrolyte fuel cell at time[i] further, and stores them in the memory, the third means preferably includes a means that calculates Vₑₛₜ[i] by using a voltage estimation model including I[i], Vₘₑₛ[i], Tₘₑₛ[i], Rᵢₒₙ[i], and updated Pₘ[i] and Qₙ[i] and stores thus-calculated Vₑₛₜ[i] in the memory.

### 1.4. Fourth Means

The fourth means is a means that calculates a corrected parameter Pₘ*[i] and/or a corrected internal state Qₙ*[i] by using, instead of the CF[i−1], a provisional correction factor CF*[i−1] arbitrarily selected from within a range between −δ₁ to +δ₂,
calculates a corrected value of estimated voltage Vₑₛₜ*[i] by using the voltage estimation model including the Pₘ*[i] and the Qₙ*[i],
determines whether or not the Vₑₛₜ*[i] satisfies the following determination formula: |Vₘₑₛ[i]−Vₑₛₜ*[i]|≤|Vₘₑₛ[i−1]−Vₑₛₜ[i−1]|, and
stores, in the memory, the CF*[i−1] that satisfies the determination formula as a correction factor CF[i] at the time[i].

As described above, the voltage estimation model includes various physical models ranging from a simple model to a rigorous model. When a simple model is used as the voltage estimation model, Vₑₛₜ[i] is likely to deviate from Vₘₑₛ[i] with the passage of time.

When a rigorous model is used as the voltage estimation model, on the other hand, deviation of Vₑₛₜ[i] from Vₘₑₛ[i] becomes smaller compared with the use of a simple model. Even when a rigorous model is used, however, deviation of Vₑₛₜ[i] from Vₘₑₛ[i] may increase with the passage of time due to variation due to individual difference (variation in machine difference), modeling error, unknown factors which cannot be modeled, and the like.

In the present invention, to solve the aforesaid problem, at least one of Pₘ[i] (m≥1) and/or Qₙ[i] included in the voltage estimation model is corrected so as to decrease an absolute value of the difference between Vₘₑₛ[i] and Vₑₛₜ[i] with each calculation step. More specifically, the correction of Pₘ[i] and Qₙ[i] is achieved by the correction of a correction factor CF[i].

As described above, CF[i−1] is for correcting the error of Vₑₛₜ[i] that occurs by a cause other than fault. Therefore, when an absolute value |ΔV[i]=|Vₘₑₛ[i]−Vₑₛₜ[i] of the difference between Vₘₑₛ[i] and Vₑₛₜ[i] calculated using CF[i−1] is |ΔV[i−1]| or less, the CF[i−1] value is appropriate and there is less necessity of changing CF[i−1].

Even when no fault has occurred, however, Vₑₛₜ[i] gradually deviates from Vₘₑₛ[i] due to various factors. In the present invention, therefore, CF[i] is corrected so that |ΔV[i]| decreases at each calculation step, thereby bring Vₑₛₜ[i] closer to Vₘₑₛ[i].

The correction of CF[i] is performed specifically by
(a) calculating “a corrected parameter Pm*[i]” and/or “a corrected internal state Qₙ*[i]” in a manner similar to that of the first means except for the use of “a provisional correction factor CF*[i−1]” arbitrarily selected from within a range between −δ₁ to +δ₂ (δ₁ and δ₂ are each an arbitrary value) instead of CF[i−1],
(b) calculating “a corrected value of estimated voltage Vₑₛₜ*[i]” in a manner similar to that of the third means except for the use of a voltage estimation model including Pₘ*[i] and Qₙ*[i],
(c) determining whether or not Vₑₛₜ*[i] satisfies the following determination formula: |Vₘₑₛ[i]−Vₑₛₜ*[i]|≤|Vₘₑₛ[i−1]−Vₑₛₜ[i−1], and
(d) storing, in the memory, the CF*[i−1] that satisfies the determination formula as a correction factor CF[i] at time[i].

In this case, it is also possible to search CF*[i−1] for all the values within a range between −δ₁ to +δ₂; and select, as CF[i], CF*[i−1] in which the formula |ΔV*[i]|=Vₘₑₛ[i]−Vₑₛₜ*[i]| is minimal among CF*[i−1] which satisfy the determination formula.

Alternatively, it is also possible to search CF*[i−1] in a predetermined order (for example, an ascending order of power or a descending order of power), finish the search when the CF*[i−1] that satisfies the determination formula is found; and select the CF*[i−1] at this time as CF[i].

### 1.5. Voltage Estimation Model

Various models are proposed for voltage estimation. In the present invention, the kinds of the voltage estimation model are not particularly limited and various models can be used depending on the purpose. In order to calculate Vₑₛₜ[i] by using a voltage estimation model which will be described later, it is necessary to know a catalyst potential V_{cat}[i] of a cathode catalyst and a catalyst surface utilization ratio θ_{act}[i].

### [1.5.1. Catalyst Potential V_{cat}[i]]

The term “Vₘₑₛ[i]” is a measured value of a potential difference (that is, a total voltage of a polymer electrolyte fuel cell) at both ends of a fuel cell stack at time[i].

On the other hand, strictly speaking, the term “catalyst potential V_{cat}[i] of a cathode catalyst” means a value obtained by adding a potential drop due to internal resistance to a potential of a cathode of each unit cell at time[i]. Strictly speaking, the V_{cat}[i] is calculated based on Vₘₑₛ[i], I[i], and Rᵢₒₙ[i]. When Rᵢₒₙ[i] cannot be acquired, it may be calculated by approximation calculation using only Vₘₑₛ[i]. The Rᵢₒₙ[i] can be identified by high-frequency impedance measurement.

More specifically, the V_{cat}[i] is represented by the following formula (14) or formula (15). In the present invention, either one may be used. The V_{cat}[i] thus calculated is stored in a memory.

The V_{cat}[i] represented by the formula (14) is an approximation formula of V_{cat}[i] neglecting a potential drop due to internal resistance. The formula (14) is inferior to the formula (15) in calculation accuracy. Using the formula (14) however simplifies the calculation of V_{cat}[i] because V_{cat}[i] can be calculated without using I[i] and Rᵢₒₙ[i].

Strictly speaking, the V_{cat}[i] is represented by the formula (15). In the formula (15), the first term on the right side represents a potential difference (cell voltage) between both ends of a unit cell. In the first term on the right side, a potential per cell is calculated by dividing Vₘₑₛ[i] by N_{cell}. The second term on the right side represents a potential drop due to internal resistance per cell. In the second term on the right side, I[i] and Rᵢₒₙ[i] are converted to a value per area and a value per cell, respectively. The V_{cat}[i] can be calculated accurately by using the formula (15). For accurately calculating Vₑₛₜ[i], the formula (15) is preferably used for the calculation of V_{cat}[i].

$$[ Math . 1 ]$$

$${V}_{cat} [ i ] = \frac{{V}_{mes} [ i ]}{{N}_{cell}} \qquad ( 14 )$$

$${V}_{cat} [ i ] = \frac{{V}_{mes} [ i ]}{{N}_{cell}} + ( \frac{I [ i ]}{{A}_{cell}} \times \frac{{R}_{ion} [ i ] \times {A}_{cell}}{{N}_{cell}} ) \qquad ( 15 )$$

wherein,
N_{cell} represents the stacked number of cells of the polymer electrolyte fuel cell, and
A_{cell} represents the area of the cells.

### [1.5.2. Catalyst Surface Utilization Ratio θ_{act}[i]]

The term “catalyst surface utilization ratio θ_{act}[i]” means a ratio of the area of a surface used for an oxygen reduction reaction (ORR) (that is, a surface not covered with an oxide film) to a surface area of noble metal-based catalyst particles contained in a polymer electrolyte fuel cell.

### [A. Noble Metal-Based Catalyst Particles]

In the present invention, the term “noble metal-based catalyst particles (hereinafter, also simply referred to as “catalyst particles”) refer to particles composed of a metal or alloy containing noble metal element and having oxygen reduction reaction (ORR) activity.

In the present invention, the material of the catalyst particles is not particularly limited as long as it exhibits ORR activity. Examples of the material of the catalyst particles include:
(a) a noble metal (Au, Ag, Pt Pd, Rh, Ir, Ru, and Os),
(b) an alloy containing two or more noble metal elements, and
(c) an alloy containing one or two or more noble metal elements and one or two or more base metal elements (such as Fe, Co, Ni, Cr, V, and Ti).

### [B. Kind of Oxide]

When catalyst particles on the cathode side are exposed to a high potential, a catalyst component is likely to elute from the catalyst particles. On the other hand, when the catalyst particles are exposed to a high potential, an oxide film (including a hydroxide) is formed on the surface of the catalyst particles and elution of the catalyst component from the catalyst particles is suppressed. However, since the formation rate of the oxide film is slow, a rapid fluctuation of the potential of the cathode retards the formation of the oxide film, making it easier to elute the catalyst component from the catalyst particles. That is, when the fuel cell is continuously used under the environment in which the rapid potential fluctuation is repeated, the catalyst particles will eventually deteriorate.

In other words, the durability of the noble metal-based catalyst particles on the cathode side depends on the total amount of a noble metal oxide and a noble metal hydroxide present on the surface of the noble metal-based catalyst particles.

On the other hand, among surfaces of the noble metal-based catalyst particles, the surface covered with the oxide film has lower ORR activity than the surface not covered with the oxide film. Therefore, the IV characteristics of the polymer electrolyte fuel cell depend on the θ_{act}[i] of the catalyst particles.

The noble metal oxide present on the surface of the noble metal-based catalyst particles can be roughly classified into
(a) a noble metal hydroxide adsorbed on the surface of the noble metal-based catalyst particles,
(b) a noble metal oxide A adsorbed on the surface of the noble metal-based catalyst particles, and
(c) a noble metal oxide B formed just below the surface of the noble metal-based catalyst particles by the diffusion of oxygen into the inside of the particles.

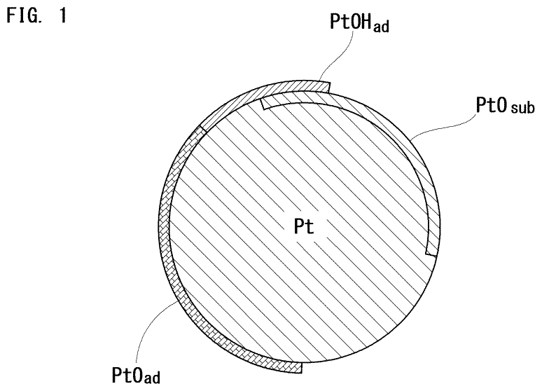

FIG. 1 illustrates a cross-sectional schematic view of a Pt particle having an oxide film thereon. When the Pt particle is exposed to a high potential, an oxide (including a hydroxide) is formed on the surface of the Pt particle.

In this case, the oxide on the surface of the Pt particle includes
(a) a Pt hydroxide (PtOH_{ad}) adsorbed on the surface of the Pt particle,
(b) a Pt oxide (PtO_{ad}) adsorbed on the surface of the Pt particle, and
(c) a Pt oxide (PtO_{sub}) formed just below the surface of the Pt particle by the diffusion of oxygen into the inside of the Pt particle.

Here, a coverage of the noble metal hydroxide adsorbed on the surface of the noble metal-based catalyst particles such as PtOH_{ad} at time [i] is defined as θₒₓ₁[i]. The θₒₓ₁[i] is represented by a ratio (=S₁/S₀) of an area (S₁) of the noble metal hydroxide adsorbed on the surface of the noble metal-based catalyst particles to a surface area (S₀) of the noble metal-based catalyst particles.

Similarly, a coverage of the noble metal oxide A adsorbed on the surface of the noble metal-based catalyst particles such as PtO_{ad} at time[i] is defined as θₒₓ₂[i]. The θₒₓ₂[i] is represented by a ratio (=S₂/S₀) of an area (S₂) of the noble metal oxide A adsorbed on the surface of the noble metal-based catalyst particles to S₀.

Similarly, a coverage of the noble metal oxide B present inside the noble metal-based catalyst particles such as PtO_{sub} at time[i] is defined as θₒₓ₃[i]. The θₒₓ₃[i] is represented by a ratio (=S₃/S₀) of an area (S₃) of the noble metal oxide B present inside the noble metal-based catalyst particles to S₀.

As illustrated in FIG. 1, the PtO_{sub} may be formed just below a region where the PtOH_{ad} or the PtO_{ad} has adsorbed on the surface of the Pt particle. Therefore, the coverage of the entire Pt particle does not necessarily match the sum of θₒₓ₁[i] to θₒₓ₃[i].

The θₒₓ₁[i] to θₒₓ₃[i] can be determined by sequentially calculating using a reaction model based on a reaction rate equation. In addition, when θₒₓ₁[i] to θₒₓ₃[i] are found, θ_{act}[i] can be calculated using them.

### [C. Reaction Model]

There are various methods for calculating the θ_{act}[i]. In the present invention, the calculation method of the θ_{act}[i] is not particularly limited and the optimum method can be used depending on the purpose. The θ_{act}[i] thus calculated is stored in a memory.

In particular, the θ_{act}[i] is preferably calculated using the following formula (3) or formula (4). In the present invention, the θ_{act}[i] may be calculated using either of these formulas.

$$[ Math . 2 ]$$

$${θ}_{act} [ i ] = {α}_{1} - {α}_{2} ( {θ}_{ox 1} [ i ] + {θ}_{ox 2} [ i ] ) - {α}_{3} \frac{{θ}_{ox 3} [ i ]}{( {θ}_{ox 1} [ i ] + {θ}_{ox 2} [ i ] )} \qquad ( 3 )$$

$${θ}_{act} [ i ] = {α}_{1} - {α}_{2} \times {θ}_{ox 1} [ i ] - {α}_{3} \times {θ}_{ox 2} [ i ] - {α}_{4} \times {θ}_{ox 3} [ i ] \qquad ( 4 )$$

$${θ}_{ox 1} [ i ] = {θ}_{ox 1} [ i - 1 ] + {T}_{s} \times \frac{{v}_{1} [ i ] - {v}_{2} [ i ]}{Γ} \qquad ( 5 )$$

$${θ}_{ox 2} [ i ] = {θ}_{ox 2} [ i - 1 ] + {T}_{s} \times \frac{{v}_{2} [ i ] - {v}_{3} [ i ]}{Γ} \qquad ( 6 )$$

$${θ}_{ox 3} [ i ] = {θ}_{ox 3} [ i - 1 ] + {T}_{s} \times \frac{{v}_{3} [ i ]}{Γ} \qquad ( 7 )$$

$${v}_{1} [ i ] = {α}_{11} \{ ( 1 - {θ}_{ox 1} [ i - 1 ] - {θ}_{ox 2} [ i - 1 ] ) \times exp ( {α}_{12} \times {G}_{1} [ i ] ) - {θ}_{ox 1} [ i - 1 ] \times exp ( - {α}_{13} \times {G}_{i} [ i ] ) \} \qquad ( 8 )$$

$${v}_{2} [ i ] = {α}_{21} \{ {θ}_{ox 1} [ i - 1 ] \times exp ( {α}_{22} \times {G}_{2} [ i ] ) - {θ}_{ox 2} [ i - 1 ] \times exp ( - {α}_{23} \times {G}_{2} [ i ] ) \} \qquad ( 9 )$$

$${v}_{3} [ i ] = {α}_{31} \{ ( 1 - {θ}_{ox 3} [ i - 1 ] \times {θ}_{ox 2} [ i - 1 ] ) \times exp ( {α}_{32} \times {G}_{3} [ i ] ) - {θ}_{ox 3} [ i - 1 ] \times ( 1 - {θ}_{ox 1} [ i - 1 ] - {θ}_{ox 2} [ i - 1 ] \times exp ( - {α}_{33} \times {G}_{3} [ i ] ) \} \qquad ( 10 )$$

$${G}_{1} [ i ] = {V}_{cat} [ i ] - {α}_{14} - {a}_{15} \times {θ}_{ox 1} [ i - 1 ] - {α}_{16} \times {θ}_{ox 2} [ i - 1 ] - {a}_{17} \times {θ}_{ox 3} [ i - 1 ] \qquad ( 11 )$$

$${G}_{2} [ i ] = {V}_{cat} [ i ] - {α}_{24} - {a}_{25} \times {θ}_{ox 1} [ i - 1 ] - {α}_{26} \times {θ}_{ox 2} [ i - 1 ] - {α}_{27} \times {θ}_{ox 3} [ i - 1 ] \qquad ( 12 )$$

$${G}_{3} [ i ] = {V}_{cat} [ i ] - {a}_{34} - {a}_{35} \times {θ}_{ox 1} [ i - 1 ] - {a}_{36} \times {θ}_{ox 2} [ i - 1 ] - {α}_{37} \times {θ}_{ox 3} [ i - 1 ] \qquad ( 13 )$$

wherein,
θₒₓ₁[i] is a coverage of the noble metal hydroxide adsorbed on the surface of noble metal-based catalyst particles contained in the polymer electrolyte fuel cell at the time[i] and is represented by the formula (5),
θₒₓ₂[i] is a coverage of the noble metal oxide A adsorbed on the surface of the noble metal-based catalyst particles at the time[i] and is represented by the formula (6),
θₒₓ₃[i] is a coverage of the noble metal oxide B present inside the noble metal-based catalyst particles at the time[i] and is represented by the formula (7),
Γ is the maximum surface covering oxygen amount (constant) per unit surface area,
v₁[i] to v₃[i] are a formation/disappearance reaction rate of the noble metal hydroxide, the noble metal oxide A, and the noble metal oxide B at the time[i] and are represented by the formulas (8) to (10), respectively,
G₁[i] to G₃[i] are free energy of reactions of v₁[i] to v₃[i] at the time[i] and are represented by the formulas (11) to (13), respectively,
Tₛ is a calculation step width,
α₁ to α₄, α₁₁ to α₁₇, α₂ to α₂₇, and α₃₁ to α₃₇ are each a fitting coefficient, and
V_{cat}[i] is a catalyst potential of a cathode of the polymer electrolyte fuel cell at the time[i].

The Tₛ specifically represents a time interval from time[i−1] to time[i]. The value of the Tₛ is not particularly limited and the optimum value is preferably set depending on the purpose.

The α₁ to α₃₇ are each preferably determined to match actual IV characteristics or test results obtained by cyclic voltammetry (CV). In the present invention, the α₁ to α₃₇ may be treated as a “variable constant”.

As shown in the formulas (5) to (13), v₁[i] to v₃[i] and G₁[i] to G₃[i] are used for the calculation of θₒₓ₁[i], θₒₓ₂[i], and θₒₓ₃[i]. In the present invention, the θₒₓ₁[i], θₒₓ₂[i], and θₒₓ₃[i]may be treated as a “state quantity” that may change with time[i].

The θₒₓ₂[i−1], θₒₓ₂[i−1], and θₒₓ₃[i−1] are each a coverage at time[i−1] and have already been stored in a memory. The θₒₓ₂[i−1], θₒₓ₂[i−1], and θₒₓ₃[i−1] can be obtained by sequential calculation if initial values are known. As the initial value, a value at the time of the previous stop may be held and used as the initial value. In general, when the fuel cell is stopped, it is often retained at a low potential and, at that time, all the oxides are reduced. Therefore, the initial value after the fuel cell is stopped may be set at θₒₓ₁=θₒₓ₂=θₒₓ₃=0.

Therefore, when the V_{cat}[i] is acquired, the θ_{act}[i] can be calculated from the formula (3) or (4).

In the formula (4), the θ_{act}[i] is calculated by subtracting, from all the surface (β₁), the products obtained by multiplying respective coverages by coefficients (a₂ to α₄). The θₒₓ₁[i] represents a coverage of a hydroxide due to one-electron reaction.

The θₒₓ₂[i] and θₒₓ₃[i] each represent a coverage of oxides due to two-electron reaction. Assuming that one platinum surface site is consumed per one electron reaction, the following equations: α₁=1, α₂=1, α₃=2, and α₄=2 hold. In actual use, since the platinum surface is not uniform, α₁ to α₄ are determined to match the test results.

However, the formula (4) does not consider that the surface oxide species (coverages θₒₓ₁[i] and θₒₓ₂[i]) and inside oxide species (coverage θₒₓ₃[i]) generate at the same platinum site, and in such a case, there is a concern that the G_{act}[i] may be underestimated. For example, in a case where V_{car}[i] continues to be high, θₒₓ₁[i], θₒₓ₂[i], and θₒₓ₃[i] each increase, so that the above problem is remarkable, and there is a concern about a decrease in accuracy.

On the other hand, the formula (3) has an advantage that estimation can be performed with high accuracy even in the above case by taking a ratio between the surface oxide species and the inside oxide species. In the other case, on the other hand, there is a concern that the accuracy of the formula (3) may be lower than that of the formula (4).

### 1.5.3. Specific Example of Voltage Estimation Model

Various models are proposed for voltage estimation. The voltage estimation model is particularly preferably represented by the following formula (1).

$$[ Math . 3 ]$$

$${V}_{est} [ i ] = {V}_{ocv} - \frac{R {T}_{mes} [ i ]}{α F} log ( \frac{I [ i ]}{{I}_{0} [ i ]} ) - \frac{R {T}_{mes} [ i ]}{α F} log ( \frac{{C}_{ref}}{{C}_{{O}_{2}} - \frac{{R}_{gas}}{4 F} I [ i ]} ) - {R}_{ion} I [ i ] \qquad ( 1 )$$

$${I}_{0} [ i ] = {A}_{1} {r}_{act} [ i ] exp ( \frac{3.8 \times 1 {0}^{4}}{R {T}_{mes} [ i ]} ) {θ}_{act} [ i ] \qquad ( 2 )$$

wherein,
V_{ocv} is an open-circuit voltage of the polymer electrolyte fuel cell,
R is a gas constant,
α is a Butler-Volmer transfer constant,
F is a Faraday constant,
ε_{ref} is a reference oxygen concentration in cell,
C_{O2} is an average oxygen concentration in cell,
R_{gas} is gas diffusion resistance,
Rᵢₒₙ is ohmic resistance,
I₀[i] is an exchange current density and is represented by the formula (2),
A₁ is a fitting coefficient,
r_{act}[i] is a catalyst activity retention rate, and
θ_{act}[i] is a catalyst surface utilization ratio.

In the formula (1), the first term on the right side represents an open circuit electromotive force, the second term on the right side represents an activation overvoltage, the third term on the right side represents a concentration overvoltage, and the fourth term on the right side represents a resistance overvoltage.

In the formula (1), the term “reference oxygen concentration ε_{ref} in cell” means a reference value of an oxygen concentration in cell and it is an oxygen concentration corresponding to an oxygen partial pressure. In the present embodiment, the ε_{ref} is treated as “invariable constant” but it may be treated as “variable constant”.

In the formula (1), the term “average oxygen concentration C_{O2} in cell” means an average value of an oxygen concentration in cell. In the present embodiment, the C_{O2} is treated as an “invariable constant”, but may also be treated as a “variable constant”.

In the formula (1), the term “gas diffusion resistance R_{gas}” means transfer resistance [s/m] of oxygen and it is a coefficient when a concentration gradient [mol·mr⁻³] is indicated by a flow rate [J/mol·m⁻²·s⁻¹]. The R_{gas} has a correlation with an electrochemical surface area (ECSA) of catalyst particles. In the present embodiment, the R_{gas} is treated as a “variable constant”, but may also be treated as an “invariable constant”.

In the formula (1), Rᵢₒₙ represents ohmic resistance. The Rᵢₒₙ in the formula (1) is treated as a constant, different from that in the formula (15). In the present embodiment, the Rᵢₒₙ is treated as an “invariable constant”, but may also be treated as a “variable constant”.

In the formula (1), the term “exchange current density Iₒ[i]” means a current when an electrode reaction is under dynamic equilibrium. In the present embodiment, I₀[i] itself is not treated as a “variable constant” or a “state quantity”, but A₁ and θ_{act}[i] included in I₀[i] are each sometimes treated as a “variable constant” or a “state quantity”.

In the formula (1), the term “catalyst activity retention rate r_{act}[i]” can be calculated from an ECSA retention rate. In the present embodiment, r_{act}[i] may be treated as a “variable constant”.

### 1.5.4. Block Diagram

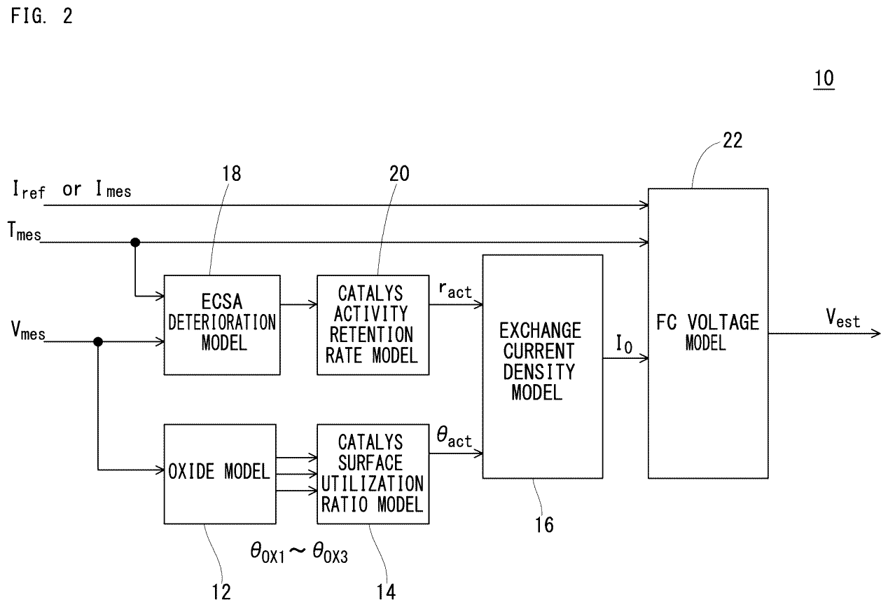

FIG. 2 illustrates a block diagram of a voltage estimation model. In FIG. 2, a voltage estimation model 10 includes an oxide model 12, a catalyst surface utilization ratio model 14, an exchange current density model 16, an ECSA deterioration model 18, a catalyst activity retention rate model 20, and an FC voltage model 22. The formula (1) is a numerical formula representing this voltage estimation model 10.

In FIG. 2, first, Vₘₑₛ[i] is input into the oxide model 12. In the oxide model 12, θₒₓ₁[i] to θₒₓ₃[i] are calculated using Vₘₑₛ[i].

The θₒₓ₁[i] to θₒₓ₃[i] thus obtained are input into the catalyst surface utilization ratio model 14. In the catalyst surface utilization ratio model 14, θ_{act}[i] is calculated using the θₒₓ₁[i] to θₒₓ₃[i]. The θ_{act}[i] thus obtained is input into the exchange current density model 16.

The Vₘₑₛ[i] and Tₘₑₛ[i] are also input into the ECSA deterioration model 18. In the ECSA deterioration model 18, an ECSA retention rate is calculated. More specifically, the ECSA retention rate can be calculated based on Vₘₑₛ[i], Tₘₑₛ[i], and humidity. The ECSA retention rate thus obtained is input into the catalyst activity retention rate model 20.

In the catalyst activity retention rate model 20, r_{act}[i] is calculated. Specifically, the r_{act}[i] can be calculated as a product of the ECSA retention rate and a specific activity (SA) retention rate. The r_{act}[i] thus calculated is input into the exchange current density model 16.

Further, in the exchange current density model 16, I₀[i] is calculated based on θ_{act}[i] and r_{act}[i].

The Tₘₑₛ[i] thus obtained and the Iₒ[i] thus calculated are input into the FC voltage model 22. The FC voltage model 22 stores therein the formula (1), and the Tₘₑₛ[i] and the Iₒ[i] are input into the formula (1). When I_{ref}[i] or Iₘₑₛ[i] is substituted into the I[i] of the formula (1) thus obtained, Vₑₛₜ[i] is output from the FC voltage model 22.

### [1.5.5. Specific Examples of Update and Correction of Pₘ[i]]

### [A. Update of Pₘ[i]: First Means]

In calculating Vₑₛₜ[i] by using the voltage estimation model represented by the formula (1), the case where A₁, α₁, α₂, α₃, α₄, and/or R_{gas} is included as Pₘ[i] to be updated in the first means is considered.

In this case, the first means preferably includes a means that
(a) uses, as the CF[i−1], a first correction factor kₘ[i−1] included in the following formula (16), and calculates the P_{m_est}[i] by using the formula (16), and
(b) updates the Pₘ[i] by using the following formula (17) based on the P_{m_est}[i] thus calculated, and stores the—thus updated Pₘ[i] in the memory.

$$[ Math . 4 ]$$

$${P}_{m\_est} [ i ] = {P}_{m -} est [ i - 1 ] + {k}_{m} [ i - 1 ] ( {V}_{mes} [ i - 1 ] - {V}_{est} [ i - 1 ] ) \qquad ( 16 )$$

$${P}_{m} [ i ] = min \{ {P}_{m\_upper} , max \{ {P}_{m - est} ( i ) , {P}_{m\_lower} \} \} \qquad ( 17 )$$

wherein,
P_{m_est}[i] is an estimated value of the Pₘ[i] calculated based on a difference between the Vₘₑₛ[i−1] and the Vₑₛₜ[i],
P_{m_est}[i−1] is an estimated value of parameter Pₘ[i−1] at the time[i−1],
kₘ[i−1] is a first correction factor,
P_{m_upper} is an upper limit allowed for the Pₘ[i], and
P_{m_lower} is a lower limit allowed for the Pₘ[i].

In the formula (16), P_{m_est}[i−1], kₘ[i−1], Vₑₛₜ[i−1], and Vₘₑₛ[i−1] have already been stored in the memory. Therefore, P_{m_est}[i] can be calculated immediately by substituting these values stored in the memory into the formula (16). The P_{m_est}[i] thus calculated based on the formula (16) is stored in the memory.

The formula (17) indicates that
(a) P_{m_est}[i] is selected as Pₘ[i] in the case of P_{m_lower}≤P_{m_est}[i]≤P_{m_upper},
(b) P_{m_lower} is selected as Pₘ[i] in the case of P_{m_est}[i]<P_{m_lower}, and
(c) P_{m_upper} is selected as Pₘ[i] in the case of P_{m_upper}<P_{m_est}[i].

The formula (17) is not always necessary, but use of the formula (17) makes it possible to correct Pₘ[i] within a range between the upper limit and the lower limit allowed for Pₘ[i]. In addition, when the formula (17) is used, the Pₘ[i] is expected to converge into a true value. The Pₘ[i] thus updated using the formula (17) is used for the calculation of Vₑₛₜ[i].

### [B. Correction of Pₘ[i]: Fourth Means]

After Vₑₛₜ[i] is calculated using the updated Pₘ[i], at least one of Pₘ[i] (m≥1) included in the voltage estimation model is corrected, in the fourth means, so as to decrease an absolute value of a difference between Vₘₑₛ[i] and Vₑₛₜ[i] for each calculation step. As described above, the correction of Pₘ[i] is performed by the correction of CF[i].

When A₁, α₁, α₂, α₃, α₄, and/or R_{gas} is included as Pₘ[i], the fourth means preferably includes a means that uses a provisional first correction factor kₘ*[i−1] as CF*[i−1], searches kₘ*[i−1] that satisfies the determination formula in accordance with the aforesaid procedure, and stores, in the memory, the kₘ*[i−1] that satisfies the determination formula as a first correction factor kₘ[i] at the time[i]. Details of the searching procedure of the kₘ*[i−1] have already been described above so that a description on them will be omitted.

The A₁ is a fitting coefficient included in the exchange current density I₀[i] and can be used for adjusting the influence on Vₑₛₜ[i] by the catalyst deterioration. For the correction of A₁, the sign of k*[i−1] is selected so that |ΔV*[i]| is reduced.

The α₁ to α₄ are each a fitting coefficient for adjusting the influence of a coverage of platinum oxide on the catalyst surface utilization ratio and they affect an estimation accuracy of reversible voltage fluctuation. The reversible voltage fluctuation is known to occur markedly in a low current density region. For the correction of α₁ to α₄, therefore, the absolute value of k*[i−1] is preferably selected so that it increases in a low current density region. The sign of k*[i−1] is selected to reduce |ΔV*[i]|.

The R_{gas} means gas diffusion resistance used in the formula (1). The influence of it appears remarkably in a high current density region. For the correction of the R_{gas}, therefore, the absolute value of k*[i−1] is preferably selected so that it increases in a high current density region. The sign of k*[i−1] is selected to reduce |ΔV*[i]|.

The same applies to the case of correcting the Pₘ[i] other than A₁, α₁, α₂, α₃, α₄, and R_{gas}, and it is preferred to correct the Pₘ[i] by using the aforesaid method.

### [1.5.6. Specific Examples of Correction and Update of Qₙ[i]]

### [A. Update of Qₙ[i]: First Means]

In the case where Vₑₛₜ[i] is calculated by using the voltage estimation model represented by the formula (1), the case where at least one of θₒₓⱼ[i] (j=1, 2, or 3) is included as Qₙ[i] to be updated in the first means is considered.

In this case, the first means preferably includes a means that
(a) uses, as the CF[i−1], a second correction factor hⱼ[i−1](j=1, 2, or 3) included in the following formulas (18) to (20), and calculates at least one of θ_{oxj_est}[i] (j=1, 2, or 3) by using the formulas (18) to (20), and
(b) updates the θₒₓⱼ[i] by using the following formula (21) based on the θ_{oxj_est}[i] thus calculated and stores the thus updated θₒₓⱼ[i] in the memory.

$$[ Math . 5 ]$$

$${θ}_{ox 1 \_ est} [ i ] = {θ}_{ox 1} [ i - 1 ] + {T}_{s} \frac{{v}_{1} [ i ] - {v}_{2} [ i ]}{Γ} + {h}_{1} [ i - 1 ] ( {V}_{mes} [ i - 1 ] - {V}_{est} [ i - 1 ] ) \qquad ( 18 )$$

$${θ}_{ox 2 \_ est} [ i ] = {θ}_{ox 2} [ i - 1 ] + {T}_{s} \frac{{v}_{2} [ i ] - {v}_{3} [ i ]}{Γ} + {h}_{2} [ i - 1 ] ( {V}_{mes} [ i - 1 ] - {V}_{est} [ i - 1 ] ) \qquad ( 19 )$$

$${θ}_{ox 3 \_ est} [ i ] = {θ}_{ox 3} [ i - 1 ] + {T}_{s} \frac{{v}_{3} [ i ]}{Γ} + {h}_{3} [ i - 1 ] ( {V}_{mes} [ i - 1 ] - {V}_{est} [ i - 1 ] ) \qquad ( 20 )$$

$${θ}_{oxj} [ i ] = min \{ {θ}_{oxj\_upper} , max \{ {θ}_{oxj\_est} [ i ] , {θ}_{oxj\_lower} \} \} \qquad ( 21 )$$

wherein,
θ_{ox1_est}[i], θ_{ox2_est}[i], and θ_{ox3_est}[i] are estimated values of the θₒₓ₁[i], the θₒₓ₂[i], and the θₒₓ₃[i], respectively, each obtained by calculating based on a difference between the Vₘₑₛ[i−1] and the Vₑₛₜ[i−1],
θₒₓ₁[i−1], θₒₓ₂[i−1], and θₒₓ₃[i−1] are coverages of the noble metal hydroxide, the noble metal oxide A, and the noble metal oxide B at the time[i−1], respectively,
θ_{ox1_upper}, θ_{ox2_upper}, and θ_{ox3_upper} are upper limits allowed for the θₒₓ₁[i], the θₒₓ₂[i], and the θₒₓ₃[i], respectively,
θ_{ox1_lower}, θ_{ox2_lower}, and θ_{ox3_lower} are lower limits allowed for the θₒₓ₁[i], the θₒₓ₂[i], and the θₒₓ₃[i], respectively,
h₁[i−1], h₂[i−1], and h₃[i−1] are second correction factors, respectively, and
j=1, 2, or 3.

In the formulas (18) to (20), θₒₓ₁[i−1], Tₛ, vⱼ[i], θ, hⱼ[i−1], Vₘₑₛ[i−1], and Vₑₛₜ[i−1] have already been stored in the memory. Therefore, θ_{oxj_est}[i] can be calculated immediately by substituting these values stored in the memory into the formulas (18) to (20). The θ_{oxj_est}[i] thus calculated based on the formulas (18) to (20) has been stored in the memory.

The formula (21) indicates that
(a) θ_{oxj_est}[i] is selected as θₒₓ₁[i] in the case of θ_{oxj_lower}≤θ_{oxj_est}[i]≤θ_{ox1_upper},
(b) θ_{oxj_lower} is selected as θₒₓ₁[i] in the case of θ_{oxj_est}[i]<θ_{oxj_lower}, and
(c) θ_{oxj_upper} is selected as θₒₓ₁[i] in the case of θ_{oxj_upper}<θ_{oxj_est}[i].

The formula (21) is not always necessary, but using the formula (21) makes it possible to correct θₒₓ₁[i] within a range between the upper limit and the lower limit allowed for θₒₓ₁[i]. In addition, when the formula (21) is used, the θₒₓⱼ[i] is expected to converge into a true value. The θₒₓⱼ[i] thus updated using the formula (21) is used for the calculation of Vₑₛₜ[i].

### [B. Correction of Qₙ[i]: Fourth Means]

After Vₑₛₜ[i] is calculated using the updated Qₙ[i], at least one of Qₙ[i] (n≥1) included in the voltage estimation model is corrected, in the fourth means, so as to decrease an absolute value of a difference between Vₘₑₛ[i] and Vₑₛₜ[i] for each calculation step. As described above, the correction of Qₙ[i] is performed by the correction of CF[i].

When at least one of θₒₓⱼ[i] (j=1, 2, or 3) is included as Qₙ[i], the fourth means preferably includes a means that uses a provisional second correction factor h*[i−1] as the CF*[i−1], searches h*[i−1] that satisfies the determination formula in accordance with the aforesaid procedure, and stores, in the memory, the h*[i−1] that satisfies the determination formula as the second correction factor hⱼ[i] at the time [i]. Details of the searching procedure of the h*[i−1] have already been described above so that a description on them will be omitted.

The θₒₓⱼ[i] has a correlation with temporary voltage fluctuation due to the internal state of a polymer electrolyte fuel cell. When the θₒₓⱼ[i] is corrected, the sign of the hⱼ*[i−1] is selected to decrease |ΔV*[i]|.

When the θₒₓ₁[i] to θₒₓ₃[i] are corrected by the aforesaid method, the deviation of Vₑₛₜ[i] from Vₘₑₛ[i] influenced by an oxide film is automatically corrected. As a result, even if reversible voltage fluctuation occurs due to an oxide film, the estimation accuracy of Vₑₛₜ[i] improves.

### 1.6. Specific Examples of Condition-Estimating Device

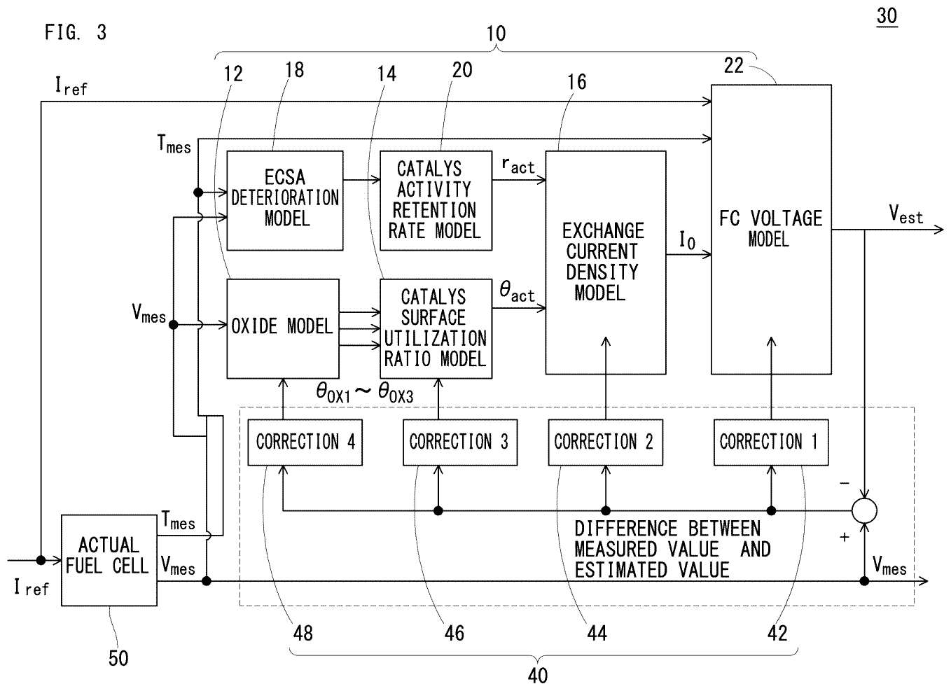

FIG. 3 illustrates a block diagram of a condition-estimating device having a voltage estimation model and means for correcting a parameter Pₘ[i] and an internal state Qₙ[i]. In FIG. 3, the condition-estimating device 30 includes a voltage estimation model 10 and correction means 40.

The voltage estimation model 10 includes an oxide model 12, a catalyst surface utilization ratio model 14, an exchange current density model 16, an ECSA deterioration model 18, a catalyst activity retention rate model 20, and an FC voltage model 22. The details of the voltage estimation model 10 are similar to those of FIG. 2 so that a description on them will be omitted.

The correction means 40 includes first correction means 42 connected to the FC voltage model 22, second correction means 44 connected to the exchange current density model 16, third correction means 46 connected to the catalyst surface utilization ratio model 14, and fourth correction means 48 connected to the oxide model 12.

Although not shown in the drawing, the correction means 40 may further has fifth correction means connected to the ECSA deterioration model 18 and/or sixth correction means connected to the catalyst activity retention rate model 20.

The first correction means 42 is a means for correcting a parameter Pₘ[i] (for example, R_{gas} included in the formula (1)) and/or an internal state Qₙ[i], each related to the FC voltage model 22.

Similarly, the second correction means 44 is a means for correcting a parameter Pₘ[i] (for example, a fitting coefficient A₁ included in the formula (2)) and/or an internal state Qₙ[i], each related to the exchange current density model 16.

Similarly, the third correction means 46 is a means for correcting a parameter Pₘ[i] (for example, a fitting coefficient α₁ to α₄ included in the formulas (3) and (4)) and/or Qₙ[i], each related to the catalyst surface utilization ratio model 14.

Similarly, the fourth correction means 48 is s means for correcting an internal state Qₙ[i] (for example, θₒₓ₁[i] to θₒₓ₃[i] included in the formulas (3) and (4)) and/or a parameter Pₘ[i], each related to the oxide model 12.

By the actual operation of the fuel cell 50 at time[i] so that the current is equal to the I_{ref}[i], Vₘₑₛ[i] and Tₘₑₛ[i] are output from the fuel cell 50. When I_{ref}[i], Vₘₑₛ[i], and Tₘₑₛ[i] are input into the voltage estimation model 10, Vₑₛₜ[i] is output from the voltage estimation model 10.

Next, a difference between the Vₑₛₜ[i] output from the voltage estimation model 10 and Vₘₑₛ[i] output from the fuel cell 50 is input into the correction means 40. In each of the first correction means 42 to the fourth correction means 48, CF*[i−1] that satisfies the following determination formula: |ΔV*|<|ΔV[i−1]| is searched and the CF*[i−1] that satisfies the determination formula is stored in the memory as CF[i]. The CF[i] is used for the calculation of P_{m_est}[i+1] and/or Q_{n_est}[i+1] at the subsequent time [i+1].

Using the condition-estimating device 30 illustrated in FIG. 3 makes it possible to automatically prevent the estimated voltage value Vₑₛₜ[i] calculated using a physical model from deviating from the measured voltage value Vₘₑₛ[i] which is affected by voltage fluctuation due to variation in machine difference, catalyst deterioration, or an oxide film. In other words, the condition-estimating device 30 can automatically exclude the aforesaid factors that cause deviation of Vₑₛₜ[i] from Vₘₑₛ[i].

### 2. Fault-Determining Device

The fault-determining device according to the present invention includes fault determination means that makes a fault determination of a polymer electrolyte fuel cell by using at least one value selected from the group consisting of
(a) an estimated voltage value Vₑₛₜ[i] of the polymer electrolyte fuel cell at the time[i],
(b) an estimated parameter value P_{m_est}[i] (m≥1) at the time[i], and
(c) an estimated internal state value Q_{n_est}[i] (n≥1) at the time[i],
   each output from the condition-estimating device according to the present invention.

When there occurs, in a polymer electrolyte fuel cell, only a steady voltage reduction due to catalyst deterioration and/or temporary voltage fluctuation due to the formation/reduction of an oxide film, a value or changing manner of Pₘ[i] and Qₙ[i] can be found or estimated in advance. When there occurs a voltage reduction due to fault, on the other hand, Vₑₛₜ[i] is not likely to be directly affected by the fault so that Vₑₛₜ[i] calculated using the voltage estimation model deviates largely from Vₘₑₛ[i].

When there occurs fault, therefore, by correcting Pₘ[i] and/or Qₙ[i] to bring Vₑₛₜ[i] closer to Vₘₑₛ[i], the value or changing manner of Pₘ[i] and Qₙ[i] changes largely before and after the fault. As a result, the presence or absence of the fault can be accurately estimated based on a changing amount of Vₑₛₜ[i], Pₘ[i] before correction (that is, P_{m_est}[i]), and/or Qₙ[i] before correction (that is, Q_{n_est}[i]).

### [2.1. Fault Determination Using Vₑₛₜ[i]]

The fault determination means may include
(A) first determination means that determines fault when an absolute value of a difference between the measured voltage value Vₘₑₛ[i] and the Vₑₛₜ[i] of a polymer electrolyte fuel cell at the time[i] is a first threshold value ε₁ or more, or exceeds the ε₁, and/or
(B) second determination means that determines fault when an integrated absolute value Σ|Vₘₑₛ[i]−Vₑₛₜ[i]| of a difference between the Vₘₑₛ[i] and the Vₑₛₜ[i] is a second threshold value ε₂ or more, or exceeds the ε₂.

### 2.1.1. First Determination Means

As described above, Vₑₛₜ[i] may deviate largely from Vₘₑₛ[i] when fault occurs. In the present invention, on the other hand, Pₘ[i] and/or Qₙ[i] is corrected to coincide the Vₑₛₜ[i] with the Vₘₑₛ[i] but the Vₑₛₜ[i] itself calculated at time[i] has been stored in the memory without being corrected. Therefore, it is possible to determine that there is a high possibility of fault occurrence when Vₘₑₛ[i]−Vₑₛₜ[i] is the first threshold value ε₁ or more, or exceeds the ε₁.

In this case, the magnitude of ε₁ is not particularly limited and the optimum value can be selected, depending on the purpose. The ε₁ may be made belong to the side of “true” or the side of “false” for proposition. This also applies to another threshold.

### 2.1.2. Second Determination Means

When fault occurs, it may be followed by a drastic reduction in Vₘₑₛ[i] or a gradual reduction in Vₘₑₛ[i]. In the latter case and when a calculation step width Tₛ is narrow, it may be difficult to determine fault by using the IVₘₑₛ[i]−Vₑₛₜ[i]|. In such a case, fault determination is preferably conducted using an integrated value of |Vₘₑₛ[i]−Vₑₛₜ[i]|.

When a continuous voltage reduction due to the fault occurs, Σ|Vₘₑₛ[i]−Vₑₛₜ[i]| is gradually increased. Therefore, it is possible to determine that there is a high possibility of fault occurrence when Σ|Vₘₑₛ[i]−Vₑₛₜ[i]| is the second threshold value ε₂ or more, or exceeds the ε₂.

### [2.2. Fault Determination Using P_{m_est}[i]]

The fault determination means may include
(A) third determination means that determines fault when the P_{m_est}[i] exceeds the upper limit P_{m_upper} allowed for the Pₘ[i](P_{m_upper}<P_{m_est}[i]), or the P_{m_est}[i] is the P_{m_upper} or more (P_{m_upper}≤P_{m_est}[i]),
(B) fourth determination means that determines fault when an integrated value regarding time [i]Σᵢ (P_{m_est}[i]−P_{m_upper}) of a difference between the P_{m_est}[i] and the P_{m_upper} is a third threshold value ε₃ or more, or exceeds the ε₃,
(C) fifth determination means that determines fault when the P_{m_est}[i] is less than the lower limit P_{m_lower} allowed for the Pₘ[i](P_{m_est}[i]<P_{m_lower}), or the P_{m_est}[i] is the P_{m_lower} or less (P_{m_est}[i]≤P_{m_lower}), and/or
(D) sixth determination means that determines fault when an integrated value regarding time [i]Σᵢ (P_{m_lower}−P_{m_est}[i]) of a difference between the P_{m_est}[i] and the P_{m_lower} is a fourth threshold value ε₄ or more, or exceeds the ε₄.

### 2.2.1. Third Determination Means

As described above, the P_{m_est}[i] is calculated using the formula (16). When Vₘₑₛ[i−1] shows an abnormal value because of fault, therefore, the P_{m_est}[i] may exceed an upper limit P_{m_upper} allowed for Pₘ[i]. Therefore, it can be determined that there is a high possibility of fault occurrence when P_{m_upper}<P_{m_est}[i] or P_{m_upper}≤P_{m_est}[i].

### 2.2.2. Fourth Determination Means

Even if no fault occurs, P_{m_est}[i] may temporarily exceed P_{m_upper} because of a cause other than fault. In such a case, fault determination with the third means may lead to a determination error.

On the other hand, when fault occurs, P_{m_est}[i] may exceed P_{m_upper} at an increased frequency. When an integrated value regarding time [i]Σᵢ (P_{m_est}[i]−P_{m_upper}) is the third threshold value ε₃ or more, or exceeds the ε₃, it can be determined that there is a high possibility of fault occurrence.

### 2.2.3. Fifth Determination Means

Contrary to the third means, when Vₘₑₛ[i−1] shows an abnormal value due to fault, P_{m_est}[i] may be less than the lower limit P_{m_lower} allowed for Pₘ[i]. Therefore, when the following formula: P_{m_est}[i]<P_{m_lower} or P_{m_est}[i]≤P_{m_lower} holds, it is possible to determine that there is a high possibility of fault occurrence.

### 2.2.4. Sixth Determination Means

Even if no fault occurs, P_{m_est}[i] may temporarily fall below P_{m_lower} due to a cause other than fault. In such a case, fault determination using the fifth means may lead to a determination error.

On the other hand, when fault occurs, P_{m_est}[i] may be less than P_{m_lower} at an increased frequency. When an integrated value regarding time[i]Σᵢ (P_{m_lower}−P_{m_est}[i]) is a fourth threshold value ε₄ or more, or exceeds the ε₄, it can be determined that there is a high possibility of fault occurrence.

### [2.3. Fault Determination Using Q_{n_est}[i]]

When Q_{n_est}[i] includes at least one of θ_{oxj_est}[i] (j=1, 2, or 3),
the fault determination means may include
(A) seventh determination means that determines fault when the θ_{oxj_est}[i] (j=1, 2, or 3) exceeds an upper limit θ_{Oxj_upper} allowed for the θₒₓⱼ[i] (θ_{oxj_upper}<θ_{oxj_est}[i]), or when the θ_{oxj_est}[i] is the θ_{oxj_upper} or more (θ_{oxj_upper}≤θ_{oxj_est}[i]),
(B) eighth determination means that determines fault when an integrated value regarding time[i]Σᵢ (θ_{oxj_est}[i]−θ_{oxj_upper}) of a difference between the θ_{oxj_est}[i] and the θ_{oxj_upper} is a fifth threshold value ε₅ or more, or exceeds the ε₅,
(C) ninth determination means that determines fault when the θ_{oxj_est}[i] is less than a lower limit θ_{oxj_lower} allowed for the θₒₓⱼ[i](θ_{oxj_est}[i]<θ_{oxj_lower}) or when the θ_{oxj_est}[i] is the θ_{oxj_lower} or less (θ_{oxj_est}[i]≤θ_{oxj_lower}), and/or,
(D) tenth determination means that determines fault when an integrated value regarding time [i] Σᵢ (θ_{oxj_lower}−θ_{oxj_est}[i]) of a difference between the θ_{oxj_est}[i] and the θ_{oxj_lower} is a sixth threshold value ε₆ or more, or exceeds the ε₆.

In the present invention, θₒₓ₁[i] may be corrected in order to suppress deviation of Vₑₛₜ[i] from Vₘₑₛ[i] due to a cause other than fault. In this case, when Vₑₛₜ[i] deviates largely from Vₘₑₛ[i] due to fault, θ_{oxj_est}[i] may exceed the upper limit θ_{oxj_upper} allowed for θₒₓ₁[i] or fall below the lower limit θ_{oxj_lower} allowed for θₒₓⱼ[i].

Therefore, by monitoring a magnitude relationship between θ_{oxj_est}[i] and θ_{oxj_upper} or θ_{oxj_lower}, or an integrated value regarding time[i] of the difference between these, it is possible to determine whether or not fault has occurred. A description on the other point on the seventh to tenth determination means will be omitted because they are similar to the third to sixth determination means.

### 3. Condition-Estimating/Fault-Determining Device

The condition-estimating/fault-determining device according to the present invention includes
the condition-estimating device according to the present invention and
the fault-determining device according to the present invention.

The details of the condition-estimating device and the fault-determining device have already been described above so that a description on them will be omitted.

### 4. Flow Chart

### 4.1. First Embodiment

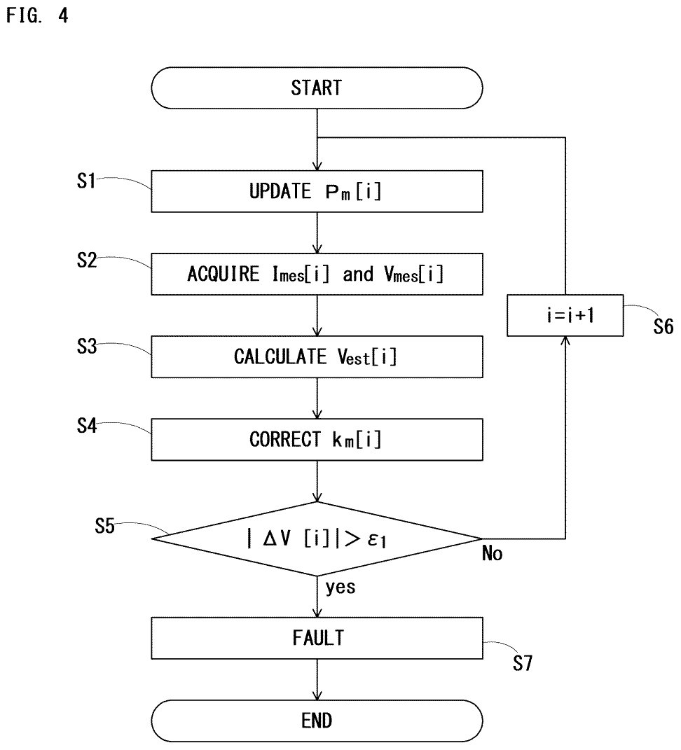

FIG. 4 illustrates a flow chart for executing the state estimation and fault determination according to a first embodiment of the present invention. FIG. 4 illustrates an example in which only Pₘ[i] correction is performed.

First, Pₘ[i] is updated in Step 1 (which will hereinafter be called “S1”, simply) (first means). More specifically, a voltage estimation model used for calculating an estimated voltage value Vₑₛₜ[i] of a polymer electrolyte fuel cell at time[i] and including at least one parameter Pₘ[i] at time[i] and/or at least one internal state Qₙ[i] at time[i] is stored in a memory.

Then, by using an estimated voltage value Vₑₛₜ[i−1], a measured voltage value Vₘₑₛ[i−1], and a correction factor CF[i−1] at time[i−1] of the polymer electrolyte fuel cell, at least one of an estimated parameter value P_{m_est}[i] (m≥1) at time[i] is calculated. Further, based on the thus-calculated P_{m_est}[i], Pₘ[i] is updated and the thus-updated Pₘ[i] is stored in the memory. The aforesaid formulas (16) and (17) are preferably used for the update of Pₘ[i].

Next, in S2, a current I[i] and a measured voltage value Vₘₑₛ[i] of the polymer electrolyte fuel cell at time[i] are acquired successively and they are stored in the memory (second means). In S2, a measured temperature value Tₘₑₛ[i] of the polymer electrolyte fuel cell at time[i] and a measured ohmic resistance value Rᵢₒₙ[i] of the polymer electrolyte fuel cell at time[i] may be acquired further and they may be stored in the memory. Alternatively, S2 may be executed prior to S1.

Next, in S₃, by using a voltage estimation model including I[i], Vₘₑₛ[i], and the updated Pₘ[i], Vₑₛₜ[i] is calculated and the thus-calculated Vₑₛₜ[i] is stored in the memory (third means).

Next, in S₄, kₘ[i] is corrected (fourth means). The details of a kₘ[i] correction method have already been described above so that a description on them will be omitted.

Then, the process proceeds to S5. In S5, whether or not |ΔV[i]| is larger than the first threshold value ε₁ is determined (first determination means). If the formula |ΔV[i]>ε₁ does not hold (S₅: NO), there is a high possibility that fault has not occurred. In this case, the process proceeds to S6 and 1 is added to time[i]. Then, the process returns to S1. When the next calculation time comes, each of the aforesaid steps S1 to S6 is repeated.

If the formula |ΔV[i]|>ε₁ holds (S5: YES), on the other hand, there is a high possibility of fault occurrence. In this case, the process proceeds to S7 and fault occurrence is notified.

In the example illustrated in FIG. 4, presence or absence of fault is determined by whether or not the formula |ΔV[i]|>ε₁ holds, but instead, presence or absence of fault may be determined by
(a) whether or not the following formula: Σ|ΔV[i]|>ε₂ holds (second determination means),
(b) whether or not the following formula: P_{m_upper}<P_{m_est}[i] holds (third determination means),
(c) whether or not the following formula: Σᵢ(P_{m_est}[i]−P_{m_upper})>ε₃ holds (fourth determination means),
(d) whether or not the following formula: P_{m_est}[i]<P_{m_lower} holds (fifth determination means), and/or
(e) whether or not the following formula: Σᵢ(P_{m_lower}−P_{m_est}[i])>ε₄ holds (sixth determination means).

### 4.2. Second Embodiment

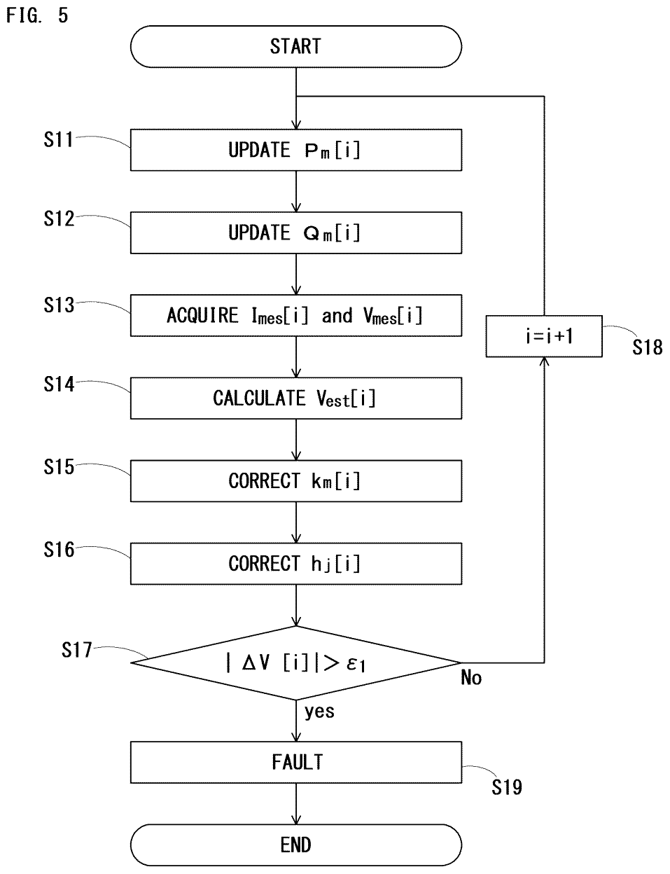

FIG. 5 illustrates a flow chart for executing the state estimation and fault determination according to a second embodiment of the present invention. FIG. 5 illustrates an example in which Pₘ[i] and Qₙ[i] are corrected.

First, in S11, Pₘ[i] is updated (first means). The aforesaid formulas (16) and (17) are preferably used for the update of Pₘ[i].

Next, in S12, Qₙ[i] is updated (first means). The aforesaid formulas (18) to (21) are preferably used for the update of Qₙ[i].

Next, in S13, I[i] and Vₘₑₛ[i] are successively acquired and they are stored in a memory (second means). The step S13 may also be a step in which Tₘₑₛ[i] and Rᵢₒₙ[i] are acquired further and they are stored in the memory. Alternatively, S13 may be executed prior to S11.

Next, in S14, Vₑₛₜ[i] is calculated using a voltage estimation model including I[i], Vₘₑₛ[i], and updated Pₘ[i] and Qₙ[i], and the thus-calculated Vₑₛₜ[i] is stored in the memory (third means).

Next, in S15, kₘ[i] is corrected (fourth means). The details of the kₘ[i] correction method have been described above so that a description on them will be omitted.

Then, in S16, h [i] is corrected (fourth means). The details of the h [i] correction method have been described above so that a description on them will be omitted.

Next, the process proceeds to S17. In S17, whether or not |ΔV[i]| is larger than ε₁ is determined (first determination means). When the following formula: |ΔV[i]|>ε₁ does not hold (S17: NO), there is a high possibility that fault has not occurred. In this case, the process proceeds to S18 and 1 is added to time[i].

Then, the process returns to S11. When the next calculation time comes, the aforesaid steps S11 to S18 are each repeated.

On the other hand, when the following formula |ΔV[i]|>ε₁ holds (S17: YES), there is a high possibility of fault occurrence. In this case, the process proceeds to S19 and fault occurrence is notified.

In the example illustrated in FIG. 5, presence or absence of fault is determined by whether or not the formula |ΔV[i]|>ε₁ holds, but instead, presence or absence of fault may be determined by
(a) whether or not the following formula: Σ|ΔV[i]|>ε₂ holds (second determination means),
(b) whether or not the following formula: θ_{oxj_upper}<θ_{oxj_est}[i] holds (seventh determination means),
(c) whether or not the following formula: Σᵢ(θ_{oxj_est}[i]−θ_{oxj_upper})>ε₅ holds (eighth determination means)
(d) whether or not the following formula: θ_{oxj_est}[i]<θ_{oxj_lower} holds (ninth determination means), and/or
(e) whether or not the following formula: Σᵢ (θ_{oxj_lower}−θ_{oxj_est}[i])>ε₆ holds (tenth determination means).

Instead, without S11 and S15, only update and correction of θₒₓⱼ[i] may be executed.

### 5. Effect

### 5.1. State Estimation

There are many voltage estimation models for estimating the voltage of a polymer electrolyte fuel cell. By using such voltage estimation models, an estimated voltage value Vₑₛₜ[i] of the polymer electrolyte fuel cell at time[i] can be calculated. By using a voltage estimation model that takes into account a steady voltage reduction due to catalyst deterioration or a temporary voltage fluctuation due to the formation/reduction of an oxide film, Vₑₛₜ[i] taking into account the influence of a steady voltage reduction or the influence of a temporary voltage fluctuation can be obtained.

The voltage estimation model includes a model parameter necessary for voltage estimation. For accurate estimation of the voltage of a fuel cell, it is necessary to set the model parameter to correspond to a real machine. It is therefore the ordinary practice to perform parameter fitting by using the least square method to match model estimation results to experiment results as much as possible.

However, there may be a difference (variation in machine difference) in these parameter values determined for a particular experiment subject when subjects are different from each other. There may also be a case where after parameter fitting, with the passage of time, deviation of an estimated voltage value Vₑₛₜ[i] calculated from a voltage estimation model from a measured voltage value Vₘₑₛ[i] increases, and this prevents complete reproduction of Vₘₑₛ[i]. This is presumed to occur because there is a modeling error or an unknown factor that cannot be modeled. It is therefore necessary to determine a parameter for each subject or at regular intervals to improve the estimation accuracy of Vₑₛₜ[i]. Unless otherwise, Vₑₛₜ[i] is presumed to deviate from Vₘₑₛ[i].

On the other hand, it is possible to suppress large deviation of Vₑₛₜ[I] from Vₘₑₛ[i] by correcting, when Vₑₛₜ[i] is calculated using a voltage estimation model, at least one of a parameter Pₘ[i] and an internal state Qₙ[i] included in the voltage estimation model so as to bring Vₑₛₜ[i] closer to Vₘₑₛ[i], and calculating Vₑₛₜ[i] using the corrected Pₘ[i] and Qₙ[i].

### 5.2. Fault Determination

In a case where Vₘₑₛ[i] is calculated using a voltage estimation model, when fault occurs, there is a possibility of Vₑₛₜ[i] deviating from Vₘₑₛ[i]. On the other hand, deviation of Vₑₛₜ[i] from Vₘₑₛ[i] also occurs due to variation in machine difference, deterioration in catalyst particles, and the like in addition to fault. In calculating Vₑₛₜ[i] by using a voltage estimation model, it is therefore difficult to determine fault/non-fault when there occurs large deviation of Vₑₛₜ[i] from Vₘₑₛ[i] due to a cause other than fault.

In this case, frequent parameter fitting may improve the voltage estimation accuracy. Even in such a case, however, it is not always possible to accurately determine fault/non-fault only by comparing instantaneous values of Vₑₛₜ[i] and Vₘₑₛ[i].

On the other hand, when there occurs, in a polymer electrolyte fuel cell, only a steady voltage reduction due to catalyst deterioration and/or a temporary voltage fluctuation due to the formation/reduction of an oxide film, a value or changing manner of the Pₘ[i] and Qₙ[i] can be found or estimated in advance.

When a voltage reduction due to fault occurs, on the other hand, Vₑₛₜ[i] is less directly affected by fault so that Vₑₛₜ[i] calculated using the voltage estimation model deviates largely from Vₘₑₛ[i].

When there occurs a fault, therefore, by correcting Pₘ[i] and/or Qₙ[i] to bring Vₑₛₜ[i] closer to Vₘₑₛ[i], the value or changing manner of Pₘ[i] and Qₙ[i] changes largely between before and after the fault. As a result, the presence or absence of the fault can be estimated accurately based on a changing amount of Vₑₛₜ[i], Pₘ[i] before correction (that is, P_{m_est}[i]), and/or Qₙ[i] before correction (that is, Q_{n_est}[i]).

The embodiment of the present invention has been described above in detail, but the present invention is not limited by the aforesaid embodiment. Various modifications can be made within a range not departing from the scope of the present invention.

### INDUSTRIAL APPLICABILITY

The condition-estimating device, the fault-determining device, and the condition-estimating/fault-determining device according to the present invention can be used for the internal state estimation and/or fault determination of a polymer electrolyte fuel cell which is loaded in a fuel cell vehicle.

1. A condition-estimating device, comprising:
(A) first means that stores, in a memory, a voltage estimation model which is used for calculating an estimated voltage value Vₑₛₜ[i] of a polymer electrolyte fuel cell at time[i] and includes at least one parameter Pₘ[i] at the time[i] and/or at least one internal state Qₙ[i] at the time[i],
calculates at least one selected from the group consisting of an estimated parameter value P_{m_est}[i] (m≥1) at the time[i] and an estimated internal state value Q_{n_est}[i] (n≥1) at the time[i] by using an estimated voltage value Vₑₛₜ[i−1], a measured voltage value Vₘₑₛ[i−1], and a correction factor CF[i−1] of the polymer electrolyte fuel cell at time [i−1], and
updates the Pₘ[i] and the Qₙ[i] based on the calculated P_{m_est}[i] and Q_{n_est}[i], respectively, and stores each of the updated Pₘ[i] and Qₙ[i] in the memory;
(B) second means that, before or after performing the first means, successively acquires a current I[i] and a measured voltage value Vₘₑₛ[i] of the polymer electrolyte fuel cell at the time[i] and stores them in the memory;
(C) third means that calculates the Vₑₛₜ[i] by using the voltage estimation model including the I[i], the Vₘₑₛ[i], and the updated Pₘ[i] and Qₙ[i] and stores the thus-calculated Vₑₛₜ[i] in the memory; and
(D) fourth means that calculates a corrected parameter Pₘ*[i] and/or a corrected internal state Qₙ*[i] by using, instead of the CF[i−1], a provisional correction factor CF*[i−1] arbitrarily selecting from within a range between −δ₁ to +δ₂,
Calculates a corrected value of estimated voltage Vₑₛₜ*[i] by using the voltage estimation model including the Pₘ*[i] and the Qₙ*[i],
determines whether or not the Vₑₛₜ*[i] satisfies the following determination formula: |Vₘₑₛ[i]−Vₑₛₜ*[i]|≤|Vₘₑₛ[i−1]−Vₑₛₜ[i−1]|, and
stores, in the memory, the CF*[i−1] that satisfies the determination formula as a correction factor CF[i] at the time[i],
wherein, the term “parameter Pₘ[i]” means a constant included in the voltage estimation model and a variable constant that may change the value depending on the Vₘₑₛ[i]; and
the term “internal state Qₙ[i]” means a state quantity which is included in the voltage estimation model and may change with the time[i] but is other than the I[i] and the Vₘₑₛ[i].

2. The condition-estimating device according to claim 1, wherein the I[i] is a commanded current value I_{ref}[i] at the time[i] or a measured current value Iₘₑₛ[i] at the time[i].

3. The condition-estimating device according to claim 1, wherein the voltage estimation model includes, as the Qₙ[i], at least one of the state quantities having a correlation with temporary voltage fluctuation due to the formation/reduction of an oxide film on a surface of noble metal-based catalyst particles contained in the polymer electrolyte fuel cell.

4. The condition-estimating device according to claim 1, wherein the voltage estimation model includes, as the Pₘ[i], at least one of the variable constants having a correlation with a steady voltage reduction due to deterioration of noble metal-based catalyst particles contained in the polymer electrolyte fuel cell.

5. The condition-estimating device according to claim 1, wherein the second means includes a means that further acquires a measured temperature value Tₘₑₛ[i] of the polymer electrolyte fuel cell at the time[i] and a measured ohmic resistance value Rᵢₒₙ[i] of the polymer electrolyte fuel cell at the time[i] and stores them in the memory and the third means includes a means that calculates the Vₑₛₜ[i] by using the voltage estimation model including the I[i], the Vₘₑₛ[i], the Tₘₑₛ[i], the Rᵢₒₙ[i], and the updated Pₘ[i] and Qₙ[i] and stores the calculated Vₑₛₜ[i] in the memory.

6. The condition-estimating model according to claim 5, wherein the voltage estimation model is represented by the following formula (1):
$$[ Math . 1 ]$$
$${V}_{est} [ i ] = {V}_{ocv} - \frac{R {T}_{mes} [ i ]}{α F} log ( \frac{I [ i ]}{{I}_{0} [ i ]} ) - \frac{R {T}_{mes} [ i ]}{α F} log ( \frac{{C}_{ref}}{{C}_{{O}_{2}} - \frac{{R}_{gas}}{4 F} I [ i ]} ) - {R}_{ion} I [ i ] \qquad ( 1 )$$
$${I}_{0} [ i ] = {A}_{1} {r}_{act} [ i ] exp ( \frac{3.8 \times 1 {0}^{4}}{R {T}_{mes} [ i ]} ) {θ}_{act} [ i ] \qquad ( 2 )$$
wherein,
V_{ocv} is an open-circuit voltage of the polymer electrolyte fuel cell
R is a gas constant,
α is a Butler-Volmer transfer constant,
F is a Faraday constant,
C_{ref} is a reference oxygen concentration in cell,
Cₒ₂ is an average oxygen concentration in cell,
R_{gas} is gas diffusion resistance
Rᵢₒₙ is ohmic resistance,
I₀[i] is an exchange current density and is represented by the formula (2),
A₁ is a fitting coefficient,
r_{act}[i] is a catalyst activity retention rate, and
θ_{act}[i] is a catalyst surface utilization ratio and is represented by the following formula (3) or formula (4),
$$[ Math . 2 ]$$
$${θ}_{act} [ i ] = {α}_{1} - {α}_{2} ( {θ}_{ox 1} [ i ] + {θ}_{ox 2} [ i ] ) - {α}_{3} \frac{{θ}_{ox 3} [ i ]}{( {θ}_{ox 1} [ i ] + {θ}_{ox 2} [ i ] )} \qquad ( 3 )$$
$${θ}_{act} [ i ] = {α}_{1} - {α}_{2} \times {θ}_{ox 1} [ i ] - {α}_{3} \times {θ}_{ox 2} [ i ] - {α}_{4} \times {θ}_{ox 3} [ i ] \qquad ( 4 )$$
$${θ}_{ox 1} [ i ] = {θ}_{ox 1} [ i - 1 ] + {T}_{s} \times \frac{{v}_{1} [ i ] - {v}_{2} [ i ]}{Γ} \qquad ( 5 )$$
$${θ}_{ox 2} [ i ] = {θ}_{ox 2} [ i - 1 ] + {T}_{s} \times \frac{{v}_{2} [ i ] - {v}_{3} [ i ]}{Γ} \qquad ( 6 )$$
$${θ}_{ox 3} [ i ] = {θ}_{ox 3} [ i - 1 ] + {T}_{s} \times \frac{{v}_{3} [ i ]}{Γ} \qquad ( 7 )$$
$${v}_{1} [ i ] = {α}_{11} \{ ( 1 - {θ}_{ox 1} [ i - 1 ] - {θ}_{ox 2} [ i - 1 ] ) \times exp ( {α}_{12} \times {G}_{1} [ i ] ) - {θ}_{ox 1} [ i - 1 ] \times exp ( - {α}_{13} \times {G}_{i} [ i ] ) \} \qquad ( 8 )$$
$${v}_{2} [ i ] = {α}_{21} \{ {θ}_{ox 1} [ i - 1 ] \times exp ( {α}_{22} \times {G}_{2} [ i ] ) - {θ}_{ox 2} [ i - 1 ] \times exp ( - {α}_{23} \times {G}_{2} [ i ] ) \} \qquad ( 9 )$$
$${v}_{3} [ i ] = {α}_{31} \{ ( 1 - {θ}_{ox 3} [ i - 1 ] \times {θ}_{ox 2} [ i - 1 ] ) \times exp ( {α}_{32} \times {G}_{3} [ i ] ) - {θ}_{ox 3} [ i - 1 ] \times ( 1 - {θ}_{ox 1} [ i - 1 ] - {θ}_{ox 2} [ i - 1 ] \times exp ( - {α}_{33} \times {G}_{3} [ i ] ) \} \qquad ( 10 )$$
$${G}_{1} [ i ] = {V}_{cat} [ i ] - {α}_{14} - {a}_{15} \times {θ}_{ox 1} [ i - 1 ] - {α}_{16} \times {θ}_{ox 2} [ i - 1 ] - {a}_{17} \times {θ}_{ox 3} [ i - 1 ] \qquad ( 11 )$$
$${G}_{2} [ i ] = {V}_{cat} [ i ] - {α}_{24} - {a}_{25} \times {θ}_{ox 1} [ i - 1 ] - {α}_{26} \times {θ}_{ox 2} [ i - 1 ] - {α}_{27} \times {θ}_{ox 3} [ i - 1 ] \qquad ( 12 )$$
$${G}_{3} [ i ] = {V}_{cat} [ i ] - {a}_{34} - {a}_{35} \times {θ}_{ox 1} [ i - 1 ] - {a}_{36} \times {θ}_{ox 2} [ i - 1 ] - {α}_{37} \times {θ}_{ox 3} [ i - 1 ] \qquad ( 13 )$$
wherein,
θₒₓ₁[i] is a coverage of a noble metal hydroxide adsorbed on the surface of noble metal-based catalyst particles contained in the polymer electrolyte fuel cell at the time[i] and is represented by the formula (5),
θₒₓ₂[i] is a coverage of a noble metal oxide A adsorbed on the surface of the noble metal-based catalyst particles at the time[i] and is represented by the formula (6),
θₒₓ₃ [i] is a coverage of a noble metal oxide B present inside the noble metal-based catalyst particles at the time[i] and is represented by the formula (7),
Γ is the maximum surface covering oxygen amount (constant) per unit surface area,
v₁[i] to v₃[i] are formation/disappearance reaction rates of the noble metal hydroxide, the noble metal oxide A, and the noble metal oxide B at the time[i] and are represented by the formulas (8) to (10), respectively,
G₁[i] to G₃[i] are free energy of v₁[i] to v₃[i] reactions at the time[i] and are represented by the formulas (11) to (13), respectively,
Tₛ is a calculation step width,
α₁ to α₄, α₁₁ to α₁₇, α₂₁ to α₂₇, and α₃₁ to α₃₇ are each a fitting coefficient, and
V_{cat}[i] is a catalyst potential of a cathode of the polymer electrolyte fuel cell at the time[i] and is represented by the following formula (14) or (15),
$$[ Math . 3 ]$$
$${V}_{cat} [ i ] = \frac{{V}_{mes} [ i ]}{{N}_{cell}} \qquad ( 14 )$$
$${V}_{cat} [ i ] = \frac{{V}_{mes} [ i ]}{{N}_{cell}} + ( \frac{I [ i ]}{{A}_{cell}} \times \frac{{R}_{ion} [ i ] \times {A}_{cell}}{{N}_{cell}} ) \qquad ( 15 )$$
wherein,
N_{cell} represents the stacked number of cells of the polymer electrolyte fuel cell, and
A_{cell} represents an area of the cells.

7. The condition-estimating device according to claim 6, wherein:
the voltage estimation model includes, as the Pₘ[i], the A₁, α₁, the α₂, the α₃, the α₄, and/or the R_{gas};
the first means includes a means that uses, as the CF[i−1], a first correction factor kₘ[i−1] included in the following formula (16), and calculates the P_{m_est}[i] by using the formula (16),
updates the Pₘ[i] based on the calculated P_{m_est}[i] by using the following formula (17), and stores the updated Pₘ[i] in the memory, and
the fourth means includes a means that uses a provisional first correction factor kₘ*[i−1] as the CF*[i−1] and stores, in the memory, the kₘ*[i−1] that satisfies the determination formula as a first correction factor kₘ[i] at the time[i],
$$[ Math . 4 ]$$
$${P}_{m\_est} [ i ] = {P}_{m -} est [ i - 1 ] + {k}_{m} [ i - 1 ] ( {V}_{mes} [ i - 1 ] - {V}_{est} [ i - 1 ] ) \qquad ( 16 )$$
$${P}_{m} [ i ] = min \{ {P}_{m\_upper} , max \{ {P}_{m - est} ( i ) , {P}_{m\_lower} \} \} \qquad ( 17 )$$
wherein,
P_{m_est}[i] is an estimated value of the Pₘ[i] calculated based on a difference between the Vₘₑₛ[i−1] and the Vₑₛₜ[i],
P_{m_est}[i−1] is an estimated value of the parameter Pₘ[i−1] at the time [i−1],
kₘ[i−1] is a first correction factor,
P_{m_upper} is an upper limit allowed for the Pₘ[i], and
P_{m_lower} is a lower limit allowed for the Pₘ[i].

8. The condition-estimating device according to claim 6, wherein the voltage estimation model includes at least one of θₒₓⱼ[i] (j=1, 2, or 3) as the Qₙ[i], and
the first means includes a means that
uses, as the CF[i−1], a second correction factor hⱼ[i−1] (j=1, 2, or 3) included in the following formulas (18) to (20), and calculates at least one of θ_{oxj_est}[i]0=1, 2, or 3) by using the formulas (18) to (20), and
updates the θₒₓⱼ[i] by using the following formula (21) based on the θ_{oxj_est}[i] thus calculated and stores the—thus updated θₒₓⱼ[i] in the memory, and
the fourth means includes a means that uses a provisional second correction factor hⱼ*[i−1] as CF*[i−1] and stores, in the memory, the hⱼ*[i−1] that satisfies the determination formula as a second correction factor hⱼ[i] at the time[i],
$$[ Math . 5 ]$$
$${θ}_{ox 1 \_ est} [ i ] = {θ}_{ox 1} [ i - 1 ] + {T}_{s} \frac{{v}_{1} [ i ] - {v}_{2} [ i ]}{Γ} + {h}_{1} [ i - 1 ] ( {V}_{mes} [ i - 1 ] - {V}_{est} [ i - 1 ] ) \qquad ( 18 )$$
$${θ}_{ox 2 \_ est} [ i ] = {θ}_{ox 2} [ i - 1 ] + {T}_{s} \frac{{v}_{2} [ i ] - {v}_{3} [ i ]}{Γ} + {h}_{2} [ i - 1 ] ( {V}_{mes} [ i - 1 ] - {V}_{est} [ i - 1 ] ) \qquad ( 19 )$$
$${θ}_{ox 3 \_ est} [ i ] = {θ}_{ox 3} [ i - 1 ] + {T}_{s} \frac{{v}_{3} [ i ]}{Γ} + {h}_{3} [ i - 1 ] ( {V}_{mes} [ i - 1 ] - {V}_{est} [ i - 1 ] ) \qquad ( 20 )$$
$${θ}_{oxj} [ i ] = min \{ {θ}_{oxj\_upper} , max \{ {θ}_{oxj\_est} [ i ] , {θ}_{oxj\_lower} \} \} \qquad ( 21 )$$
wherein,
θ_{ox1_est}[i], θ_{ox2_est}[i], and θ_{ox3_est}[i] are estimated value of the θₒₓ₁[i], θₒₓ₂[i], and
θₒₓ₃[i], respectively, each obtained by calculating based on a difference between the Vₘₑₛ[i−1] and the Vₑₛₜ[i−1],
θₒₓ₁[i−1], θₒₓ₂[i−1], and θₒₓ₃[i−1] are coverages of the noble metal hydroxide, the noble metal oxide A, and the noble metal oxide B at the time [i−1], respectively,
θ_{ox1_upper}, θ_{ox2_upper}, and θ_{ox3_upper} are upper limits allowed for the θₒₓ₁[i], θₒₓ₂[i], and θₒₓ₃[i], respectively,
θ_{ox1_lower}, θ_{ox2_lower}, and θ_{ox3_lower} are lower limits allowed for the θₒₓ₁[i], θₒₓ₂[i], and θₒₓ₃[i], respectively,
h₁[i−1], h₂[i−1], and h₃[i−1] are second correction factors, respectively, and
j=1, 2, or 3.

9. A fault-determining device, comprising fault determination means that determines fault of a polymer electrolyte fuel cell by using at least one selected from the group consisting of:
(a) an estimated voltage value Vₑₛₜ[i] of the polymer electrolyte fuel cell at the time[i],
(b) an estimated parameter value P_{m_est}[i] (m≥1) at the time[i], and
(c) an estimated internal state value Q_{u_est}[i] (n≥1) at the time[i],
each value being output from the condition-estimating device as claimed in claim 1.

10. The fault-determining device according to claim 9, wherein the fault determination means includes:
(A) first determination means that determines fault when an absolute value |Vₘₑₛ[i]−Vₑₛₜ[i]| of a difference between the measured voltage value Vₘₑₛ[i] and the Vₑₛₜ[i] of the polymer electrolyte fuel cell at the time[i] is a first threshold value ε₁ or more, or exceeds the ε₁, and/or
(B) second determination means that determines fault when an integrated absolute value Σ|Vₘₑₛ[i]−Vₑₛₜ[i]| of a difference between the Vₘₑₛ[i] and the Vₑₛₜ[i] is a second threshold value ε₂ or more, or exceeds the ε₂.

11. The fault-determining device according to claim 9, wherein the fault determination means includes:
(A) third determination means that determines fault when the P_{m_est}[i] exceeds the upper limit P_{m_upper} allowed for the Pₘ[i] (P_{m_upper}<P_{m_est}[i]) or the P_{m_est}[i] is the P_{m_upper} or more (P_{m_upper}≤P_{m_est}[i]),
(B) fourth determination means that determines fault when an integrated value regarding time[i]Σᵢ(P_{m_est}[i]−P_{m_upper}) of a difference between the P_{m_est}[i] and the P_{m_upper} is a third threshold value ε₃ or more, or exceeds the ε₃,
(C) fifth determination means that determines fault when the P_{m_est}[i] is less than the lower limit P_{m_lower} allowed for the Pₘ[i] (P_{m_est}[i]<P_{m_lower}), or the P_{m_est}[i] is the P_{m_lower} or less (P_{m_est}[i]≤P_{m_lower}), and/or
(D) sixth determination means that determines fault when an integrated value regarding time[i]Σᵢ(P_{m_lower}−P_{m_est}[i]) of a difference between the P_{m_est}[i] and the P_{m_lower} is a fourth threshold value ε₄ or more, or exceeds the ε₄.

12. The fault-determining device according to claim 9, wherein
the Q_{n_est}[i] includes at least one of θ_{oxj_est}[i] (j=1, 2, or 3) output from the condition-estimating device wherein the second means includes a means that further acquires a measured temperature value Tₘₑₛ[i] of the polymer electrolyte fuel cell at the time[i] and a measured ohmic resistance value Rᵢₒₙ[i] of the polymer electrolyte fuel cell at the time[i] and stores them in the memory and the third means includes a means that calculates the Vₑₛₜ[i] by using the voltage estimation model including the I[i], the Vₘₑₛ[i], the Tₘₑₛ[i], the Rᵢₒₙ[i], and the updated Pₘ[i] and θₙ[i] and stores the calculated Vₑₛₜ[i] in the memory;
wherein the voltage estimation model is represented by the following formula (1):
$$\underline{[ Math . 1 ]}$$
$${V}_{est} [ i ] = {V}_{ocv} - \frac{R {T}_{mes} [ i ]}{α F} log ( \frac{I [ i ]}{{I}_{0} [ i ]} ) - \frac{R {T}_{mes} [ i ]}{α F} log ( \frac{{C}_{ref}}{{C}_{{O}_{2}} - \frac{{R}_{gas}}{4 F} I [ i ]} ) - {R}_{ion} I [ i ] \qquad ( 1 )$$
$${I}_{0} [ i ] = {A}_{1} {r}_{act} [ i ] exp ( \frac{3.8 \times 1 {0}^{4}}{R {T}_{mes} [ i ]} ) {θ}_{act} [ i ] \qquad ( 2 )$$
wherein,
V_{OCV} is an open-circuit voltage of the polymer electrolyte fuel cell
R is a gas constant,
α is a Butler-Volmer transfer constant,
F is a Faraday constant,
C_{ref} is a reference oxygen concentration in cell,
Cₒ₂ is an average oxygen concentration in cell,
R_{gas} is gas diffusion resistance
Rᵢₒₙ is ohmic resistance,
I₀[i] is an exchange current density and is represented by the formula (2),
A₁ is a fitting coefficient,
r_{act}[i] is a catalyst activity retention rate, and
θ_{act}[i] is a catalyst surface utilization ratio and is represented by the following formula (3) or formula (4),
$$\begin{matrix}\underline{[ Math . 2 ]} & \end{matrix}$$
$${θ}_{act} [ i ] = {α}_{1} - {α}_{2} ( {θ}_{ox 1} [ i ] + {θ}_{ox 2} [ i ] ) - {α}_{3} \frac{{θ}_{ox 3} [ i ]}{( {θ}_{ox 1} [ i ] + {θ}_{ox 2} [ i ] )} \qquad ( 3 )$$
$${θ}_{act} [ i ] = {α}_{1} - {α}_{2} \times {θ}_{ox 1} [ i ] - {α}_{3} \times {θ}_{ox 2} [ i ] - {α}_{4} \times {θ}_{ox 3} [ i ] \qquad ( 4 )$$
$${θ}_{ox 1} [ i ] = {θ}_{ox 1} [ i - 1 ] + {T}_{s} \times \frac{{v}_{1} [ i ] - {v}_{2} [ i ]}{Γ} \qquad ( 5 )$$
$${θ}_{ox 2} [ i ] = {θ}_{ox 2} [ i - 1 ] + {T}_{s} \times \frac{{v}_{2} [ i ] - {v}_{3} [ i ]}{Γ} \qquad ( 6 )$$
$${θ}_{ox 3} [ i ] = {θ}_{ox 3} [ i - 1 ] + {T}_{s} \times \frac{{v}_{3} [ i ]}{Γ} \qquad ( 7 )$$
$${v}_{1} [ i ] = {α}_{11} \{ ( 1 - {θ}_{ox 1} [ i - 1 ] - {θ}_{ox 2} [ i - 1 ] ) \times exp ( {α}_{12} \times {G}_{1} [ i ] ) - {θ}_{ox 1} [ i - 1 ] \times exp ( - {α}_{13} \times {G}_{i} [ i ] ) \} \qquad ( 8 )$$
$${v}_{2} [ i ] = {α}_{21} \{ {θ}_{ox 1} [ i - 1 ] \times exp ( {α}_{22} \times {G}_{2} [ i ] ) - {θ}_{ox 2} [ i - 1 ] \times exp ( - {α}_{23} \times {G}_{2} [ i ] ) \} \qquad ( 9 )$$
$${v}_{3} [ i ] = {α}_{31} \{ ( 1 - {θ}_{ox 3} [ i - 1 ] \times {θ}_{ox 2} [ i - 1 ] ) \times exp ( {α}_{32} \times {G}_{3} [ i ] ) - {θ}_{ox 3} [ i - 1 ] \times ( 1 - {θ}_{ox 1} [ i - 1 ] - {θ}_{ox 2} [ i - 1 ] \times exp ( - {α}_{33} \times {G}_{3} [ i ] ) \} \qquad ( 10 )$$
$${G}_{1} [ i ] = {V}_{cat} [ i ] - {α}_{14} - {a}_{15} \times {θ}_{ox 1} [ i - 1 ] - {α}_{16} \times {θ}_{ox 2} [ i - 1 ] - {a}_{17} \times {θ}_{ox 3} [ i - 1 ] \qquad ( 11 )$$
$${G}_{2} [ i ] = {V}_{cat} [ i ] - {α}_{24} - {a}_{25} \times {θ}_{ox 1} [ i - 1 ] - {α}_{26} \times {θ}_{ox 2} [ i - 1 ] - {α}_{27} \times {θ}_{ox 3} [ i - 1 ] \qquad ( 12 )$$
$${G}_{3} [ i ] = {V}_{cat} [ i ] - {a}_{34} - {a}_{35} \times {θ}_{ox 1} [ i - 1 ] - {a}_{36} \times {θ}_{ox 2} [ i - 1 ] - {α}_{37} \times {θ}_{ox 3} [ i - 1 ] \qquad ( 13 )$$
wherein,
θₒₓ₁[i] is a coverage of a noble metal hydroxide adsorbed on the surface of noble metal-based catalyst particles contained in the polymer electrolyte fuel cell at the time[i] and is represented by the formula (5),
θₒₓ₂[i] is a coverage of a noble metal oxide A adsorbed on the surface of the noble metal-based catalyst particles at the time[i] and is represented by the formula (6),
θₒₓ₃[i] is a coverage of a noble metal oxide B present inside the noble metal-based catalyst particles at the time[i] and is represented by the formula (7),
Γ is the maximum surface covering oxygen amount (constant) per unit surface area,
v₁[i] to v₃[i] are formation/disappearance reaction rates of the noble metal hydroxide, the noble metal oxide A, and the noble metal oxide B at the time[i] and are represented by the formulas (8) to (10), respectively,
G₁[i] to G₃[i] are free energy of v₁[i] to v₃[i] reactions at the time[i] and are represented by the formulas (11) to (13), respectively,
Tₛ is a calculation step width,
α₁ to α₄, α₁₁ to α₁₇, α₂₁ to α₂₇, and α₃₁ to α₃₇ are each a fitting coefficient, and
V_{cat}[i] is a catalyst potential of a cathode of the polymer electrolyte fuel cell at the time[i] and is represented by the following formula (14) or (15),
$$\begin{matrix}\underline{[ Math . 3 ]} & \end{matrix}$$
$${V}_{cat} [ i ] = \frac{{V}_{mes} [ i ]}{{N}_{cell}} \qquad ( 14 )$$
$${V}_{cat} [ i ] = \frac{{V}_{mes} [ i ]}{{N}_{cell}} + ( \frac{I [ i ]}{{A}_{cell}} \times \frac{{R}_{ion} [ i ] \times {A}_{cell}}{{N}_{cell}} ) \qquad ( 15 )$$
wherein,
N_{cell} represents the stacked number of cells of the polymer electrolyte fuel cell, and
A_{cell} represents an area of the cells;
wherein the voltage estimation model includes at least one of θₒₓᵢ[i] (j=1, 2, or 3) as the θₙ[i], and
the first means includes a means that uses, as the CF[i−1], a second correction factor hⱼ[i−1] (j=1, 2, or 3) included in the following formulas (18) to (20), and calculates at least one of θ_{oxj_est}[i] (j=1, 2, or 3) by using the formulas (18) to (20), and
updates the θₒₓᵢ[i] by using the following formula (21) based on the θ_{oxi_est}[i] thus calculated and stores the—thus updated θₒₓᵢ[i] in the memory, and
the fourth means includes a means that uses a provisional second correction factor hⱼ*[i−1] as CF*[i−1] and stores, in the memory, the hⱼ*[i−1] that satisfies the determination formula as a second correction factor hᵢ[i] at the time[i],
$$\underline{[ Math . 5 ]}$$
$${θ}_{ox 1 \_ est} [ i ] = {θ}_{ox 1} [ i - 1 ] + {T}_{s} \frac{{v}_{1} [ i ] - {v}_{2} [ i ]}{Γ} + {h}_{1} [ i - 1 ] ( {V}_{mes} [ i - 1 ] - {V}_{est} [ i - 1 ] ) \qquad ( 18 )$$
$${θ}_{ox 2 \_ est} [ i ] = {θ}_{ox 2} [ i - 1 ] + {T}_{s} \frac{{v}_{2} [ i ] - {v}_{3} [ i ]}{Γ} + {h}_{2} [ i - 1 ] ( {V}_{mes} [ i - 1 ] - {V}_{est} [ i - 1 ] ) \qquad ( 19 )$$
$${θ}_{ox 3 \_ est} [ i ] = {θ}_{ox 3} [ i - 1 ] + {T}_{s} \frac{{v}_{3} [ i ]}{Γ} + {h}_{3} [ i - 1 ] ( {V}_{mes} [ i - 1 ] - {V}_{est} [ i - 1 ] ) \qquad ( 20 )$$
$${θ}_{oxj} [ i ] = min \{ {θ}_{oxj\_upper} , max \{ {θ}_{oxj\_est} [ i ] , {θ}_{oxj\_lower} \} \} \qquad ( 21 )$$
wherein,
θ_{ox1_est}[i], θ_{ox2_est}[i], and θ_{ox3_est}[i] are estimated value of the θₒₓ₁[i], θₒₓ₂[i], and θₒₓ₃[i], respectively, each obtained by calculating based on a difference between the Vₘₑₛ[i−1] and the Vₑₛₜ[i−1],
θₒₓ₁[i−1], θₒₓ₂[i−1], and θₒₓ₃[i−1] are coverages of the noble metal hydroxide, the noble metal oxide A, and the noble metal oxide B at the time[i−1], respectively,
θ_{ox1_upper}, θ_{ox2_upper}, and θ_{ox3_upper} are upper limits allowed for the θₒₓ₁[i], θₒₓ₂[i], and
θₒₓ₃[i], respectively,
θ_{ox1_lower}, θ_{ox2_lower}, and θ_{ox3_lower} are lower limits allowed for the θₒₓ₁[i], θₒₓ₂[i], and
θₒₓ₃[i], respectively,
h₁[i−1], h₂[i−1], and h₃[i−1] are second correction factors, respectively, and
j=1, 2, or 3; and
the fault determination means includes:
(A) seventh determination means that determines fault when the θ_{oxj_est}[i] (j=1, 2, or 3) exceeds an upper limit θ_{oxj_upper} allowed for the θₒₓⱼ[i] (θ_{oxj_upper}<θ_{oxj_est}[i]), or when the θ_{oxj_est}[i] is the θ_{oxj_upper} or more (θ_{oxj_upper}≤θ_{oxj_est}[i]),
(B) eighth determination means that determines fault when an integrated value regarding time[i]Σᵢ(θ_{oxj_est}[i]−θ_{oxj_upper}) of a difference between the θ_{oxj_est}[i] and the θ_{oxj_upper} is a fifth threshold value ε₅ or more, or exceeds the ε₅,
(C) ninth determination means that determines fault when the θ_{oxj_est}[i] is less than a lower limit θ_{oxj_lower} allowed for the θₒₓⱼ[i] (θ_{oxj_est}[i]<θ_{oxj_lower}), or when the θ_{oxj_est}[i] is the θ_{oxj_lower} or less (θ_{oxj_est}[i]≤θθ_{oxj_lower}), and/or
(D) tenth determination means that determines fault when an integrated value regarding time[i]Σᵢ(θ_{oxj_lower}−θ_{oxj_est}[i]) of a difference between the θ_{oxj_est}[i] and the θ_{oxj_lower} is a sixth threshold value ε₆ or more, or exceeds the ε₆.

13. A condition-estimating/fault-determining device, comprising
the condition-estimating device as claimed in claim 1, and
the fault-determining device, comprising fault determination means that determines fault of a polymer electrolyte fuel cell by using at least one selected from the group consisting of:
(a) an estimated voltage value Vₑ[i] of the polymer electrolyte fuel cell at the time[i],
(b) an estimated parameter value P_{m_est}[i] (m≥1) at the time[i], and
(c) an estimated internal state value Q_{n_est}[i] (n≥1) at the time[i],
each value being output from the condition-estimating device.
